(19) United States
(12) Patent Application Publication
(10) Pub. No.: US 2026/0239089 A1
(43) Pub. Date: Aug. 13, 2026

(54) METHODS FOR ENABLING POSITIONING OF A WIRELESS DEVICE, RELATED NETWORK NODE, RELATED RADIO NETWORK NODE, AND RELATED WIRELESS DEVICE

(71) Applicant: Sony Group Corporation, Tokyo (JP)

(72) Inventors: Erik BENGTSSON, Eslöv (SE); Fredrik RUSEK, Eslöv (SE); Johan HILL, Lund (SE)

(21) Appl. No.: 19/475,001

(22) PCT Filed: Mar. 7, 2024
(86) PCT No.: PCT/EP2024/056096

§ 371 Date: Oct. 13, 2025

(30) Foreign Application Priority Data
Apr. 28, 2023 (SE) 2350522-5

(51) Int. Cl. H04W 28/02; H04L 5/00; H04W 64/00; H04W 72/0446

(52) U.S. Cl. CPC H04W 28/0215; H04L 5/0048; H04W 64/003; H04W 72/0446

(57) ABSTRACT

Disclosed is a method, performed by a network node, for enabling positioning of a wireless device. The method comprises transmitting, to the wireless device, a first resource configuration indicative of a first resource to be used for reception of a first reference signal transmitted by a high-altitude node. The method comprises transmitting, to the wireless device, a second resource configuration indicative of a second resource to be used for communication of a second reference signal triggered by the reception of the first reference signal. The method comprises receiving, from the high-altitude node, the first reference signal transmitted in the first resource. The method comprises communicating, between the wireless device and the network node, the second reference signal in the second resource.

The present disclosure pertains to the field of wireless communications. The present disclosure relates to a method for enabling positioning of a wireless device, related network node, related radio network node, and related wireless device.

### BACKGROUND

Unmanned Aerial Vehicles (UAVs), such as drones, is a growing area in 3rd Generation Partnership Project, 3GPP, standardization work. One particular problem may be to determine the altitude of a drone, such as to determine the vertical elevation of the drone. For example, terrestrial network nodes are typically deployed at a similar elevation which may yield poor elevation accuracy in the positioning. In the presence of a satellite, altitude determination is feasible using round-trip-time, RTT, measurements. However, since the exact altitude of the satellite might be unknown, the accuracy of the altitude determination may be uncertain. A second RTT measurement requiring more resources to be used between the network node and the satellite would be needed to remove the satellite elevation from the equation. An RTT measurement implies that the satellite transmits a signal towards the drone, and upon receiving the signal the drone retransmits it back to the satellite. The satellite measures the RTT based on the signal transmission and retransmission. In other words, an RTT measurement requires accessing the satellite twice, once for transmission and once for reception. As satellite links have limited capacity in comparison with terrestrial networks, positioning techniques using RTT measurements may come with a significant overhead penalty.

### SUMMARY

Accordingly, there is a need for devices and methods which may mitigate, alleviate, or address the shortcomings existing and may provide for accurate positioning of a wireless device with limited overhead.

Disclosed is a method performed by a network node, for enabling positioning of a wireless device. The method comprises transmitting, to the wireless device, a first resource configuration indicative of a first resource to be used for reception of a first reference signal transmitted by a high-altitude node. The method comprises transmitting, to the wireless device, a second resource configuration indicative of a second resource to be used for communication of a second reference signal triggered by the reception of the first reference signal. The method comprises receiving, from the high-altitude node, the first reference signal transmitted in the first resource. The method comprises communicating, between the wireless device and the network node, the second reference signal in the second resource.

Further, a network node comprising memory circuitry, processor circuitry, and a wireless interface is disclosed. The network node is configured to perform any of the methods disclosed herein.

It is an advantage of the present disclosure that the disclosed network node enables a position of an elevated wireless device, such as elevation of the wireless device, to be accurately estimated and/or determined with minimal signaling overhead in the communications network. By providing the second resource configuration indicative of a second resource to be used for communication of a second reference signal triggered by the reception of the first reference signal from the high-altitude node, RTT measurements between the wireless device and the high-altitude node can be avoided, thus reducing the signaling overhead between the wireless device and the high-altitude node. With the disclosed method, the high-altitude node only has to access the wireless device once for transmission of reference signal(s) in the first resource. In other words, the disclosed method and disclosed network node can allow freeing up resources in a high-altitude node link, such as a satellite link, which typically has a limited capacity. By freeing up the resources in the high-altitude node link, valuable spectrum can be saved for other communication, urgent or prioritized communication. The disclosed method and disclosed network node may allow a precise estimation and/or determination of the position of the wireless device without requiring prior knowledge of the high-altitude node's position. The disclosed method and disclosed network node may be used for improving altitude determination of the wireless device given from positioning methods that are unable to perform such accurate altitude determination.

Disclosed is a method, performed by a wireless device, for positioning the wireless device. The method comprises receiving, from a network node, a first resource configuration indicative of a first resource to be used for reception of a first reference signal transmitted by a high-altitude node. The method comprises receiving, from the network node, a second resource configuration indicative of a second resource to be used for communication of a second reference signal triggered by the reception of the first reference signal. The method comprises receiving, from the high-altitude node, the first reference signal in the first resource. The method comprises communicating, between the wireless device and the network node, the second reference signal in the second resource.

Further, a wireless device comprising memory circuitry, processor circuitry, and a wireless interface is disclosed. The wireless device is configured to perform any of the methods disclosed herein.

It is an advantage of the present disclosure that the disclosed method enables the wireless device to perform a positioning procedure in relation to a position of terrestrial network nodes node while avoiding performing an RTT measurement with the high-altitude node. In other words, the disclosed method enables the wireless device to perform a positioning procedure that is independent of an absolute position of the high-altitude node, such as without requiring prior knowledge of the high-altitude node position and/or elevation. With the disclosed method and the disclosed wireless device, the wireless device only receives a first reference signal from the high-altitude node via the high-altitude node link. In other words, the signaling overhead between the wireless device and the high-altitude node may be minimized, thus freeing up resources in the high-altitude node link.

Disclosed is a method, performed by a radio network node, for enabling positioning of a wireless device. The method comprises receiving, from a scheduling network node, a first resource configuration indicative of a first resource to be used for reception of a first reference signal transmitted by a high-altitude node. The method comprises receiving, from the scheduling network node, a second resource configuration indicative of a second resource to be used for communication of a second reference signal. The communication of the second reference signal may, in one or more example methods, be triggered by the reception of the first reference signal. The method comprises receiving, from the high-altitude node, the first reference signal in a first resource. The method comprises communicating, between the wireless device and the radio network node, the second reference signal in a second resource.

Further, a radio network node comprising memory circuitry, processor circuitry, and a wireless interface is disclosed. The radio network node is configured to perform any of the methods disclosed herein.

It is an advantage of the present disclosure that the disclosed method performed by the radio network node and the disclosed radio network node enables the radio network node to perform a positioning procedure of the wireless device in relation to a position of a terrestrial network node without the need to locate the high-altitude node in advance, thus without the wireless device having to perform an RTT measurement with the high-altitude node. In other words, the signaling overhead between the wireless device and the high-altitude node may be minimized, thus freeing up resources in the high-altitude node link.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising example radio network nodes, an example core network node, and an example wireless device according to this disclosure,

FIG. 2A-2B are diagrams illustrating an example wireless communication system comprising example radio network nodes, an example high altitude node, and an example wireless device according to this disclosure,

FIG. 3 is a diagram illustrating an example wireless communication system comprising example radio network nodes, an example high altitude node, and a wireless device according to this disclosure,

FIG. 4 is a signaling diagram illustrating an example communication between an example network node and an example wireless device according to this disclosure,

FIG. 5 is a signaling diagram illustrating an example communication between one or more example radio network nodes, an example high-altitude node, an example positioning node, and an example wireless device according to this disclosure,

FIG. 6 is a signaling diagram illustrating an example communication between one or more example radio network nodes, an example high-altitude node, an example positioning node, and an example wireless device according to this disclosure,

FIG. 7A-7B show a flow-chart illustrating an example method, performed by a network node, for enabling positioning of a wireless device according to this disclosure,

FIGS. 8A-8B show a flow-chart illustrating an example method, performed by a wireless device, for positioning of the wireless device according to this disclosure,

FIG. 9 shows a flow-chart illustrating an example method, performed by a radio network node, for enabling positioning of a wireless device according to this disclosure,

FIG. 10 is a block diagram illustrating an example network node according to this disclosure,

FIG. 11 is a block diagram illustrating an example wireless device according to this disclosure,

FIG. 12 is a block diagram illustrating an example radio network node according to this disclosure, and

FIGS. 13A-13B are graphs illustrating example performances of the positioning of a wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

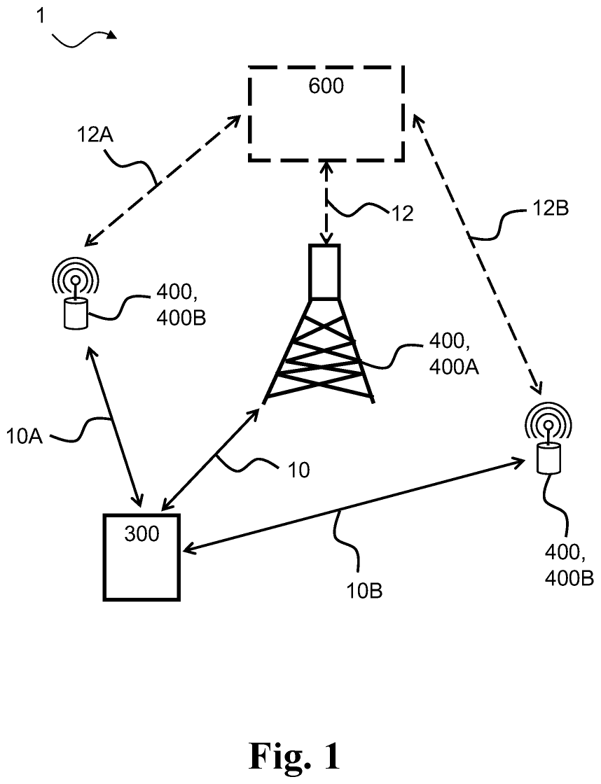

FIG. 1 is a diagram illustrating an example wireless communication system 1 comprising example radio network nodes 400, an example core network, CN, node 600, and an example wireless device 300 according to this disclosure.

As discussed in detail herein, the present disclosure relates to a wireless communication system 1 comprising a cellular system, for example, a 3GPP wireless communication system. The wireless communication system 1 comprises one or more of: a wireless device 300, radio network nodes 400, such as a first radio network node 400A, and one or more second radio network nodes 400B, and a CN node 600. The first radio network node 400A may be a scheduling radio network node, such as a radio network node providing a resource configuration to the wireless device 300, or the one or more second radio network nodes 400B. The one or more second radio network nodes 400B may be radio network nodes being scheduled by the first radio network node 400A, such as receiving a resource configuration from the first radio network node 400A. In one or more examples, a resource configuration is indicative of a time and/or frequency resource to be used for communication of signals, such as reference signals. In one or more examples, a resource configuration is seen as information indicative of an allocation of resources to be used for communication, such as transmission and/or reception, of reference signals.

A radio network node disclosed herein refers to a radio access network, RAN, node operating in the RAN, such as one or more of: a base station, BS, an evolved Node B, eNB, in 3GPP Long Term Evolution, LTE, a Next Generation Node B, gNB, in 3GPP New Radio, NR, an access point, AP, and a small cell, SC. In one or more examples, the RAN node is a functional unit which may be distributed in several physical units.

A CN node disclosed herein refers to a network node operating in the core network, such as in the Evolved Packet Core Network, EPC, and/or a 5G Core Network, 5GC. Examples of CN nodes in EPC include a Mobility Management Entity, MME, and a Location Management Function, LMF. The CN node 600 may be seen as a CN node implementing a positioning function, such as an LMF. The CN node 600 can in one or more examples be seen as a positioning node. In one or more example networks, the LMF may be a function implemented in a core network node and/or a radio network node or may be a function that is distributed over several nodes.

A wireless device may refer to one or more of: a mobile device, a user equipment, UE, and an UAV (such as, a drone).

The wireless device 300 may be configured to communicate with the radio network nodes 400, 400A, 400B via a wireless link (or radio access link) 10, 10A, 10B.

The radio network nodes 400, 400A, 400B may be configured to communicate with the CN node 600 via a wired or wireless link 12, 12A, 12B.

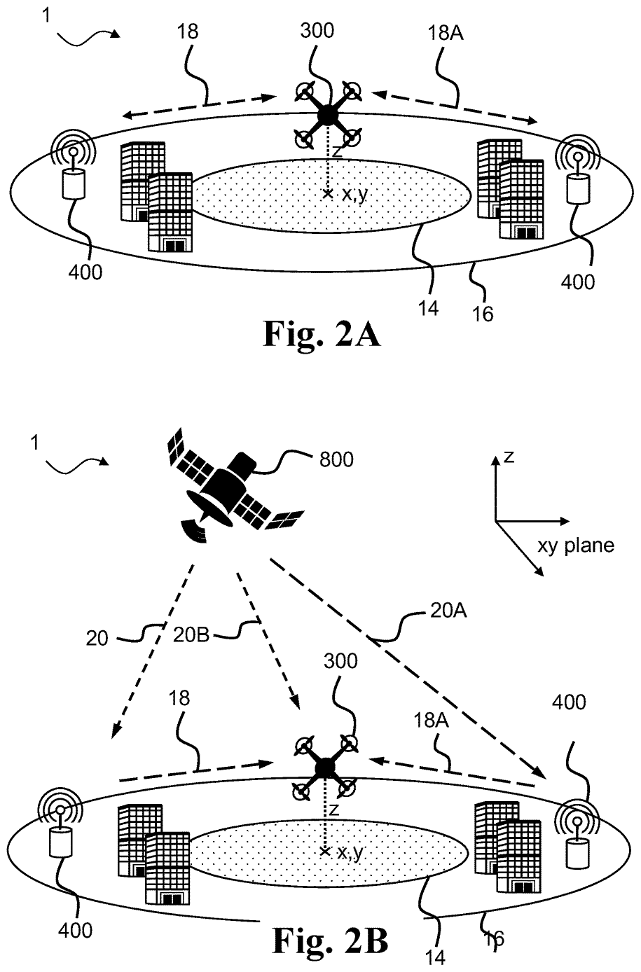

FIG. 2A-2B are diagrams illustrating an example wireless communication system 1 comprising example radio network nodes 400, an example high altitude node 800 (such as a satellite or a node), and an elevated wireless device 300 (such as a UAV and/or a drone) according to this disclosure.

As shown in FIG. 2A, the radio network nodes 400 and the elevated wireless device 300 (herein also referred to as wireless device 300) may be located within cell 16. In one or more examples, a cell can be seen as a geographic area, such as land area covered by a radio network node. The wireless device 300 may be deployed in an area 14 that has no coverage by the radio network nodes 400, such as an area outside of coverage of the radio network nodes 400. The elevated wireless device 300 may provide coverage to other wireless devices located in area 14. Area 14 may be seen as a dead zone and/or an out-of-coverage area. The wireless device 300 may be located at an altitude enabling a line-of-sight, LOS, with the radio network nodes 400, such as at an altitude high enough to allow LOS between the wireless device 300 and the radio network nodes 400 over obstacles, such as buildings and/or trees, arranged around the dead zone area 14. In other words, a LOS communication may be expected between the wireless device 300 and the radio network nodes 400. The wireless device 300 may communicate with the radio network nodes 400 via LOS wireless links 18, 18A, respectively.

It may be of interest to locate the wireless device 300, such as to determine and/or estimate its position. The position of the wireless device 300 may be represented as an xyz position, such as an xyz coordinate.

Although the xy-coordinates may be accurately estimated using trilateration techniques, such techniques may fail to accurately estimate the z-coordinate. For example, assume the location between a network node (such as, network nodes 400) and the wireless device 300 is 1 km in the xy-plane, while the z-coordinate is considerably smaller, such as 50-100 m. This may imply that an elevation angle from a radio network node 400 towards the wireless device 300 is small.

Smaller elevation angles are typically more error prone than large elevation angles, thus a small error in the estimate of the elevation angle may lead to large positioning errors, such as errors in estimating the z-coordinate.

One option to improve estimation of the z-coordinate can be to make use of a high-altitude node 800, such as a satellite, as disclosed in FIG. 2B. If the high-altitude node 800 has a known position, an RTT measurement between the high-altitude node 800 and the wireless device 300 may be sufficient to estimate the z-coordinate of the wireless device 300. Measurements between the high-altitude node 800 and the radio network nodes 400 may be needed if the position of the high-altitude node 800 is not accurately known, as illustrated in FIG. 2B. The present disclosure may allow positioning of the wireless device 300 in a 3D space, such as in the XYZ-planes, without requiring an accurate position of the high-altitude node 800.

The present disclosure provides a low overhead technique for enabling a high-altitude node (such as satellite) assisted determination of the altitude of the wireless device 300 (such as of the z-coordinate). In other words, the present disclosure provides a technique for positioning of the wireless device 300 that does not require, for example, RTT measurements between the wireless device 300 and the high-altitude node 800, thus reducing signaling overhead between the wireless device 300 and the high-altitude node 800. The present disclosure may allow freeing up resources in a high-altitude node link, such as a satellite link. This saves valuable spectrum on the high-altitude link for other types of communication, such as for low-latency and/or high-capacity communications.

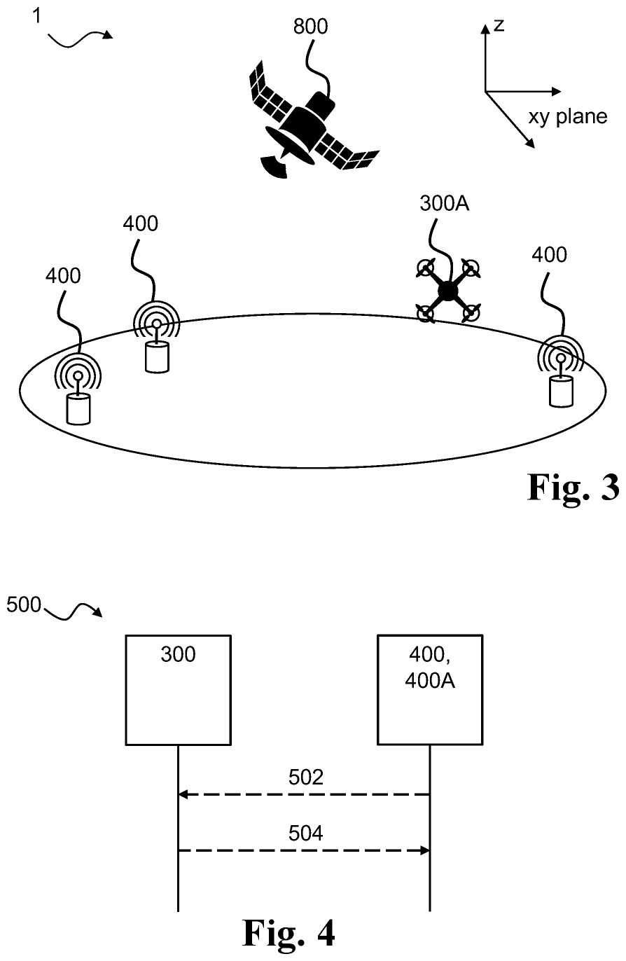

FIG. 3 is a diagram illustrating an example wireless communication system 1 comprising example radio network nodes 400, an example high altitude node 800, and a wireless device 300 according to this disclosure. The example wireless device 300 is here an elevated wireless device.

A high-altitude node disclosed herein may refer to a network node arranged at a higher altitude than the wireless device 300, such as high enough to be in a far-field regime from the radio network node. In other words, the high-altitude node 800 may be located in the far-field from the wireless device 300 and the radio network nodes 400, such as at a distance from the wireless device 300 and the radio network nodes 400 that exceeds the Fraunhofer distance. The high-altitude node may refer to an airborne network node, such as one or more of: a node in flight, an aerial network node, a satellite, and a UAV, a UAV mounted network node, and a UAV aerial network node, or to a network node fixedly mounted at a higher altitude, such as mounted on top of a mountain. For example, the high-altitude node can be seen as an orbiting and/or non-orbiting network node. The high-altitude node may refer to a non-terrestrial network (NTN) node. A high-altitude node may comprise one or more of: high altitude platforms (HPAs), low altitude platforms (LPAs), low-Earth orbit (LEO) satellites, medium-Earth orbit (MEO) satellites, and geostationary-Earth orbit (GEO) satellites.

The radio network nodes 400 may be synchronized in time with each other. The position of the radio network nodes 400 may be known.

According to the current disclosure, an accurate altitude determination of the wireless device 300 can be enabled through communication of reference signals between the disclosed entities. A reference signal can be seen as a signal that enables a proper time-of-arrival estimation or time synchronization, such as a positioning reference signal (PRS) and/or a Global Navigation Satellite System (GNSS) signal. The solution according to the current disclosure may be particularly useful for enabling determination of an altitude of the wireless device 300, such as determination of a vertical elevation of the wireless device 300 in relation to a surface (such as, ground level and/or sea level).

A network node, such as the first radio network node 400A or a positioning node 600, may be configured to allocate resources to be used for transmission and/or reception of reference signals. When the first radio network node 400A allocates resources, it may be seen as a master radio network node and/or a scheduling radio network node. The second radio network nodes 400B may be seen as radio network nodes being configured to assist the altitude determination of the wireless device 300. The radio network nodes 400 may be assisted by a positioning node, such as CN node 600. In other words, the positioning node may be configured to determine the position of the wireless device 300.

For example, the high-altitude node 800 transmits, to the radio network nodes 400 and the wireless device 300, a first reference signal. The particular number of radio network nodes performing the method disclosed herein is not limiting. For example, the wireless communication system 1 can comprise K network nodes, such as network nodes 400. For example, when the high-altitude node's position (such as, the direction to the high-altitude node) and the xy-coordinates of the wireless device 400 are not known, the method may be performed by at least K=3 radio network nodes. For example, when the high-altitude node's position and the xy-coordinates of the wireless device 400 are known, the method may be performed by at least K=1 radio network nodes. For example, when the high-altitude node's position (such as, the direction to the high-altitude node) or the xy-coordinates of the wireless device 400 are known, the method may be performed by at least K=2 radio network nodes. Each radio network node 400 may receive the first reference signal and record a respective time-of-arrival (ToA). The respective ToA associated the reception of the first reference signal by each radio network node 400 may be denoted as Tₖ, with k=1 . . . K. The wireless device 300 may receive the first reference signal at a time T_{d}. The wireless device 300 may be configured to retransmit the first reference signal towards the radio network nodes 400 at a time T_{d}+T_{Proc}. In other words, the wireless device 300 transmits a second reference signal triggered by the first reference signal received from the high-altitude node at time T_{d}+T_{Proc}. The second reference signal may be based on the first reference signal. In one or more examples, T_{Proc} can be seen as a processing time, such as a reaction time, between the reception of the first reference signal and transmission of the second reference signal by the wireless device 300. Put differently, T_{Proc} may be seen as a processing time required by the wireless device 300 to retransmit the first reference signal. Each network node 400 may record a respective ToA of the second reference signal triggered by the first reference signal, such as of the retransmitted reference signal. The respective ToA associated with the reception of the second reference signal by each radio network node 400 respectively, is herein denoted as \tilde{T}ₖ, with k=1 . . . K. The radio network nodes 400 may transmit, to the positioning node (such as to CN node 600 of FIG. 1), the ToAs associated with the reception of the first reference signal (such as Tₖ) and the ToAs associated with the reception of the second reference signal (such as \tilde{T}ₖ). The positioning node may determine a plurality of time differences based on such ToAs. The respective time differences may be denoted as tₖ=Tₖ+1−T₁, k=1 . . . K−1 for reception of the first reference signal with T₁ denoting the time of reception of the first reference signal at a primary radio network node, and \tilde{t}ₖ=\tilde{T}ₖ−\tilde{T}₁, with k=1 . . . K for reception of the second reference signal with \tilde{T}₁ denoting the time of reception of the second reference signal at a primary radio network node. The positioning node may estimate the position of the wireless device 300 based on the time differences tₖ and \tilde{T}ₖ.

By determining a time difference between reception of the first reference signal from the high-altitude node 800 and the second reference signal from the wireless device, the z-coordinate of the wireless device 300 can be determined. A determination of only xy-coordinates of the wireless device 300 may not require involvement of the high-altitude node 800. The present disclosure can allow positioning of the wireless device 300, such as determination of the xyz-coordinates of the wireless device, such as determination of the xy-coordinates and/or z-coordinate of the wireless device.

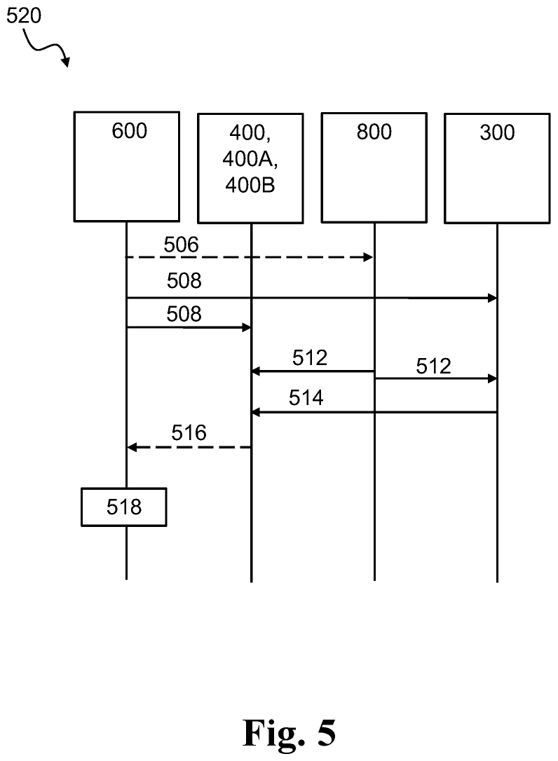

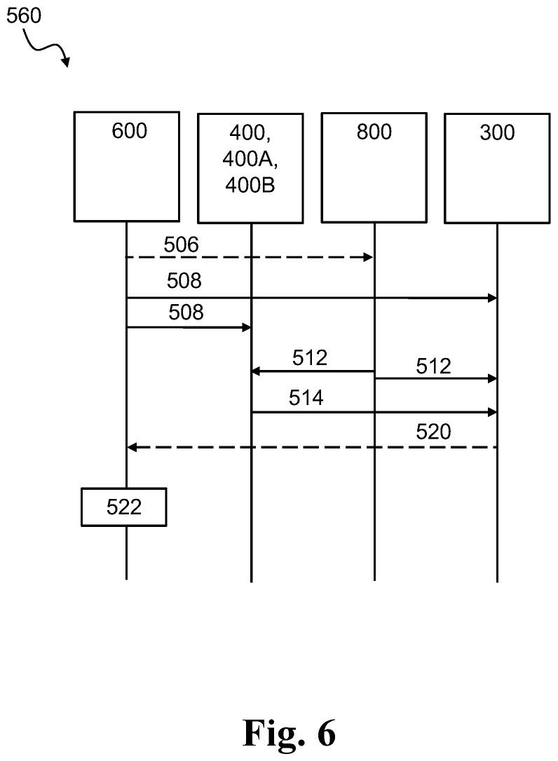

FIG. 3 and FIG. 5 illustrate an uplink (UL) based positioning procedure in which the wireless device 300 performs the transmission of the second reference signal, such as the retransmission of the first reference signal. In one or more example methods disclosed herein, a downlink (DL) based positioning procedure is provided, in which the radio network nodes 400 performs the retransmission of the first reference signal to the wireless device 300 and the wireless device 300 determines a respective ToA from the radio network nodes 400. The DL-based positioning procedure is illustrated in FIG. 6.

FIG. 4 is a signaling diagram illustrating an example communication 500 between a network node 400, such as the first network node 400A, and the wireless device 300 according to this disclosure. FIG. 4 illustrates an exchange of capability signaling between the radio network node 400 and the wireless device 300. The capability signaling may be applied to, such as may be performed prior to, an UL-based positioning procedure (such as illustrated in FIGS. 3 and 5) and/or to a DL-based positioning procedure (such as illustrated in FIG. 6).

In one or more examples, the wireless device 300 transmits capability signaling 504 in response to, for example, a capability enquiry 502 from the radio network node 400. In one or more examples, the capability signaling 504 is indicative of a capability of the wireless device 300 to support the communication of a second reference signal, such as a reference signal triggered by a first reference signal. The first reference signal may be transmitted by a high-altitude node (such as, high-altitude node 800 of FIG. 3) to the wireless device 300 and radio network nodes 400, such as radio network nodes 400A, 400B of FIG. 1.

In one or more examples, the capability signaling 504 can indicate that the wireless device is capable of performing transmission of the second reference signal (such as, transmission of the second reference signal) to one or more radio network nodes 400, such as for an UL-based positioning procedure. In one or more examples, the capability signaling 504 may indicate that the wireless device is capable of receiving the second reference signal from one or more radio network nodes 400, such as for a DL-based positioning procedure. In other words, the capability signaling may be indicative of a capability of the wireless device to support the disclosed technique.

In one or more example methods, the wireless device 300 transmits the capability signaling 504 to the first radio network node 400A as the first network node 400A is a scheduling radio network node and/or a master radio network node in relation to the radio network nodes 400B of FIG. 1. The first radio network node 400A may be assisted by a positioning node (such as, an LMF). The positioning node may schedule resources to be used for reception of the first reference signal and for communication (such as, reception and/or transmission) of the second reference signal. The radio network node 400A may transmit the respective resource configuration, such as the first resource configuration and/or the second resource configuration, indicative of the resources allocated by the positioning node. The first resource configuration is indicative of a first resource for transmission of the first reference signal. The second resource configuration is indicative of a second resource for communication of the second reference signal. The first resource configuration and the second resource configuration may each be indicative of one or more first resources and second resources respectively, such as multiple resources (e.g., in an OFDM structure), as well as re-occurring resources.

In one or more examples, the allocation of the second resource is based on the allocation of the first resource, and/or a time for the wireless device to process the transmission of the second reference signal, such as a processing delay time. In one or more examples, the first resource and the second resource can be overlapping and/or the same resource as allocation of the second resource may be based on the processing delay time. In one or more examples, a receiving node (such as the wireless device and/or the network node) that receives the first reference signal, and the second reference signal determines respective ToA based on respective channel impulse responses. In one or more examples, the capability signaling can include frequency band combinations for the first resource and/or second resource supported by the wireless device. FIG. 5 is a signaling diagram illustrating an example communication 520 between one or more radio network nodes 400, such as the first radio network node 400A and the one or more second radio network nodes 400B, a high-altitude node 800, a positioning node 600 and an example wireless device 300 according to this disclosure. FIG. 5 illustrates an UL-based positioning procedure, in which the wireless device 300 performs a retransmission of a first reference signal 512 towards the one or more network nodes 400.

In one or more examples, the first radio network node 400A and/or the positioning node 600 may have received from the wireless device 300, capability signaling (such as, capability signaling 504 of FIG. 4).

In one or more examples, the positioning node 600 transmits, to the high-altitude node 800, a resource configuration 506 via the first radio network node 400A. The resource configuration 506 may comprise a first resource configuration. For example, the first resource configuration is indicative of a first resource, such as a time and/or frequency resource, to be used for transmission of a first reference signal 512. In one or more examples, the high-altitude node 800 is configured and/or scheduled by and/or via a terrestrial node, such as a scheduling radio network node, such as the first radio network node 400A.

In one or more examples, the positioning node 600 transmits, to the one or more radio network nodes 400 and to the wireless device 300, a resource configuration 508. The resource configuration 508 may be transmitted to the wireless device 300 via the first radio network node 400A. The resource configuration 508 may comprise a first resource configuration and a second resource configuration. The first resource configuration is indicative of a first resource to be used for reception of the first reference signal 512. The second resource configuration is indicative of a second resource to be used for communication of a second reference signal 514 triggered by the reception of the first reference signal 512. In one or more examples, the second reference signal 514 is based on the first reference signal 512.

The high-altitude node 800 transmits, to the wireless device 300 and the radio network nodes 400, the first reference signal 512 in the first resource.

The wireless device 300, upon reception of the first reference signal from the high-altitude node 800, transmits, to the radio network nodes 400, a second reference signal 514. Stated differently, the wireless device 300 may perform a retransmission of the first reference signal 512 to the radio network nodes 400.

In one or more examples, the radio network nodes 400 determine, based on the first reference signal 512 and the second reference signal 514, reception timing information 516. The reception timing information 516 may be indicative of a first time (such as Tₖ of FIG. 3) associated with a reception of the first reference signal 512 by the radio network nodes 400. The reception timing information 516 may be indicative of a second time (such as \tilde{T}ₖ of FIG. 3) associated with a reception of the second reference signal 512 by the radio network nodes 400.

In one or more examples, the radio network nodes 400 transmit, to the positioning node 600, the reception timing information 516. Since, the radio network nodes 400 may not have knowledge about the other radio network node's respective reception times (such as time Tₖ, \tilde{T}ₖ), the radio network nodes 400 may share the respective reception timing information 516 with a calculating entity (such as the positioning node 600 and/or a network node assisted by the positioning node 600).

In one or more examples, the positioning node 600 determines 518, based on the received timing information 516, the location of the wireless device, such as the altitude of the wireless device 300. For example, the positioning node 600 may determine a plurality of time differences (such as, tₖ and \tilde{t}ₖ of FIG. 3) based on the reception timing information 516. A time difference may be a subtraction between the ToA of the first reference signal and/or the second reference signal at radio network nodes 400B and a time of reception of the first reference signal and/or the second reference signal at a primary radio network node. The positioning node 600 may determine the location of the wireless device 300 based on the plurality of time differences.

FIG. 6 is a signaling diagram illustrating an example communication 560 between one or more network nodes 400, 400A, 400B, a high-altitude node 800, a positioning node 600 and an example wireless device 300 according to this disclosure. The example communication 560 of FIG. 6 differs from the example communication 520 of FIG. 5 in that the one or more radio network nodes 400 perform a transmission of the second reference signal 514, such as the retransmission of the first reference signal 512 towards the wireless device 300. FIG. 6 thus illustrates a DL-based positioning procedure.

In the example communication 560, the wireless device 300 determines, based on the reference signal 512 and the second reference signal 514, reception timing information 520. The reception timing information 520 may be indicative of a first time associated with a reception of the first reference signal 512 by the wireless device 300. The reception timing information 520 may be indicative of a second time associated with a reception by the wireless device 300 of the second reference signals 512 transmitted by the one or more radio network nodes 400.

In one or more examples, the wireless device 300 transmits, to the positioning node 600, the reception timing information 520.

In one or more examples, the positioning node 600 has access to a time associated with a reception of the first reference signal 512 by the radio network nodes 400.

In one or more examples, the positioning node 600 determines 522, based on the reception timing information 520, the location of the wireless device 300, such as the altitude of the wireless device 300. In one or more examples, the positioning node 600 determines, based on the reception timing information 520 and the time associated with a reception of the first reference signal 512 by the radio network nodes 400, the location 522 of the wireless device 300.

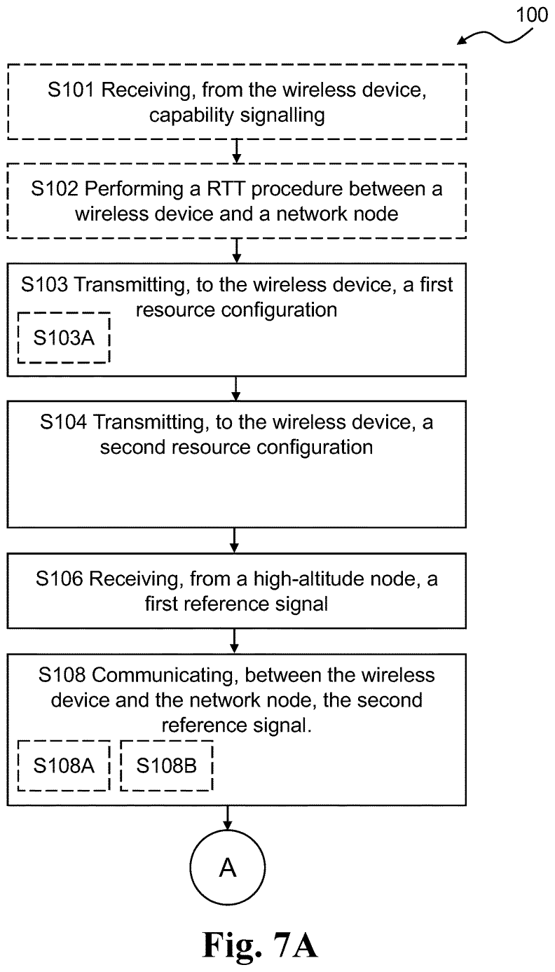

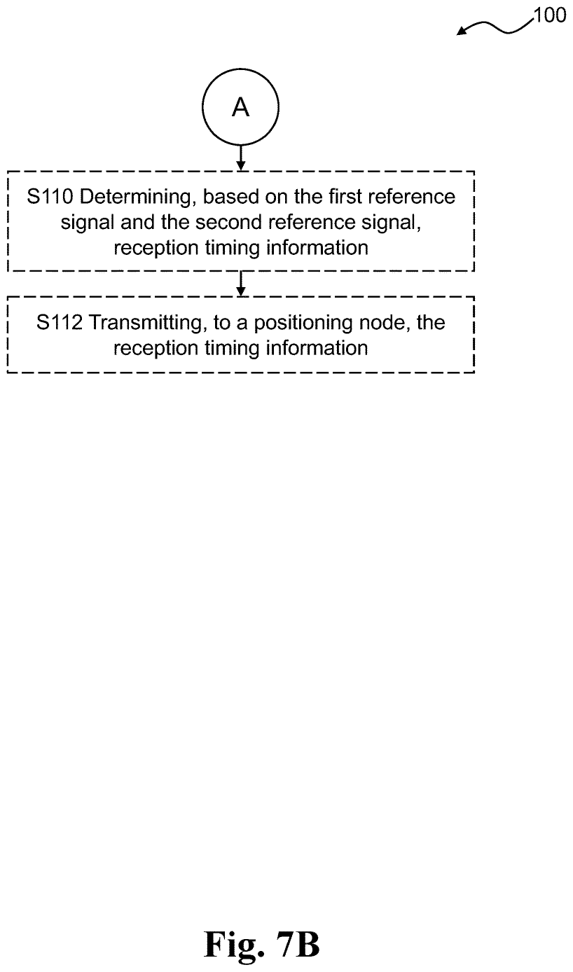

FIGS. 7A-7B show a flow-chart illustrating an example method 100, performed by a network node according to this disclosure, for enabling positioning of a wireless device. In one or more examples, the present technique enables determination of altitude of the wireless device (such as, wireless device 300 of FIGS. 1-6) using a high-altitude node (such as high-altitude node 800 of FIGS. 2B-3, and FIGS. 5-6). For example, the present technique allows determining an elevation of the wireless device without requiring an accurate position of the high-altitude node. In other words, the present technique may allow determining the elevation of the wireless device without requiring knowledge of direction of the high-altitude node. In one or more examples, the network node is a scheduling network node, such as the first radio network node 400A or the positioning node, such as positioning node 600 of FIG. 1, and FIGS. 5-6. The positioning node may communicate with the wireless device via a radio network node. In one or more examples, the wireless device is an elevated wireless device.

In one or more example methods, the method 100 comprises receiving S101, from the wireless device, capability signaling indicative of a capability of the wireless device to support the communication (such as, reception and/or transmission) of the second reference signal in the second resource. In one or more examples, the capability signaling indicates a capability according to which the wireless device is not capable of supporting the communication of the second reference signal. In one or more examples, the capability signaling indicates a capability according to which the wireless device is capable of supporting the communication of the second reference signal. In other words, the capability signaling may be indicative of a capability of the wireless device to support the disclosed technique. In one or more examples, the network node can transmit, based on the capability signaling, the first resource configuration and/or the second resource configuration. In one or more example methods, the capability signaling is indicative of a processing delay time associated with a delay of the wireless device in processing transmission of the second reference signal. In one or more examples, the capability signaling can include information indicative of frequency band combinations of the first and/or second resource. For example, the transmission of the first reference signal can be performed in different frequency band than the transmission of the second reference signal. Receiving the capability signaling S101 corresponds to receiving the capability signaling 504 in FIG. 4.

In one or more example methods, the method 100 comprises performing S102 a round-trip-time, RTT, procedure between the wireless device and the network node. In one or more examples, the wireless device and the network node may perform an RTT measurement. In one or more examples, the position of the wireless device can be determined to be on the surface of a sphere with a radius corresponding to the RTT measurement and with the network node in the center of the sphere. In one or more examples, the actual position of the wireless device can be determined based on the first reference signal (such as, transmitted by the high-altitude node) and the second reference signal (such as, transmitted by the wireless device and/or network node after a processing delay time). In one or more examples, the actual position of the wireless device can, such as when the high-altitude node is in zenith, be determined to be on a horizontal circle of the sphere. In case the high-altitude node is not in zenith, the actual position of the wireless device can be determined to be on the circle on the sphere where the area of the circle is orthogonal towards the high-altitude node. Thus, the present technique enables an accurate determination of the altitude of the wireless device.

The method 100 comprises transmitting S103, to the wireless device, a first resource configuration indicative of a first resource to be used for reception of a first reference signal transmitted by a high-altitude node. In one or more examples, the network node is the first radio network node, which may be assisted by the positioning node. The positioning node may schedule the first resource (such as a first time and/or frequency resource) and may forward the first resource configuration to the first radio network node, which transmits the first resource configuration to the wireless device, for example via the Uu interface. In one or more examples, the network node may allocate the first resource and transmit the first resource configuration indicative of the first resource to the wireless device. In one or more examples, the first resource configuration can be seen as information indicative of an allocation of the first resource to be used for reception of the first reference signal by the wireless device. The first resource configuration may configure the wireless device to listen for the first reference signal in the first resource.

In one or more examples, transmitting S103 comprises transmitting S103A, to the high-altitude node and/or to one or more radio network nodes, the first resource configuration. The first resource configuration may configure the high-altitude node to transmit the first reference signal in the first resource. In one or more examples, the transmission of the first reference signal requires to be periodically scheduled and/or scheduled on-demand. For example, the high-altitude node may be pre-configured with re-occurring transmissions of the first reference signal. The network node may configure the wireless device for receiving the first reference signal based on such pre-configuration of the high-altitude node. In this case, the network node does not have to transmit, to the high-altitude node, the first resource configuration, which frees up resources in the high-altitude node link. The network node may listen for the first reference signal based on the pre-configuration. For example, when a GNSS signal is used for enabling positioning of the wireless device, the wireless device and/or one or more radio network node(s) may synchronize to the high-altitude node and agree on the second resource, such as the time resource, for transmission of the second reference signal based on the pre-configured first resource. In this case, the second resource may not be determined based on the first resource and the processing delay time. In one or more example methods, the second reference signal is indicative of a ToA of the first reference signal and/or a time of departure (ToD) of the second reference signal. For example, the transmission of the first reference signal may be scheduled and placed in measurement gaps to enable the wireless device to receive the first reference signal together with other measurements. For example, the transmission of the first reference signal requires a reconfiguration when the network node moves outside a network cell. When the second resource is arbitrarily configurable, such as pre-configured with re-occurring transmissions of the first reference signal, the transmission of the second reference signal may not be directly triggered by the reception of the first reference signal, but may be transmitted in the second resource and being indicative of the reception time of the first reference signal, for example by a cyclic shift of a Zadoff-Chu sequence.

The method 100 comprises transmitting S104, to the wireless device, a second resource configuration. The second resource configuration is indicative of a second resource to be used for communication of a second reference signal triggered by and/or related to the reception of the first reference signal. The network node, such as the first radio network node and/or the positioning node, may schedule the second resource (such as, a second time and/or frequency resource) and transmit the second resource configuration to the wireless device. When the network node is the positioning node, the network node may transmit the second resource configuration via the first radio network node. In one or more examples, the second resource configuration can be seen as information indicative of an allocation of the second resource to be used for communication, such as transmission and/or reception, of the second reference signal. The second resource configuration may configure the wireless device to communicate the second reference signal in the second resource. In one or more examples, the second reference signal is based on the first reference signal. In one or more examples, the allocation of the second resource is based on the allocation of the first resource, and/or a processing time of the wireless device.

In one or more example methods, such as when the wireless device is configured to transmit the second reference signal in UL, the second resource configuration comprises information indicative of a processing delay time associated with a delay in processing communication of the second reference signal. The processing delay time may correspond to T_{Proc} as disclosed in relation to FIG. 3. In other words, the processing delay time may be indicative of a delay time associated with a delay in processing the transmission of the second reference signal, such as retransmission of the first reference signal, by the wireless device. The second resource may be scheduled based on the processing delay time. The processing delay time may be caused by hardware restrictions of the wireless device and may be predefined by a manufacturer of the wireless device. The processing delay time may be obtained from the capability signaling 504 of FIG. 4. The processing delay time may be indicative of the time interval between the reception of the first reference signal and the transmission of the second reference signal at the wireless device. The processing delay time may be indicated in time units, such as a number of symbols, such as Orthogonal Frequency Division Multiplexing (OFDM) symbols. In one or more examples, in case the first reference signal is reflected by the wireless device, the processing delay time may be zero, or at least approximately zero. In one or more examples, the processing delay time may be longer when the first reference signal is processed (such as, detected and/or received) by the wireless device. In other words, the transmission of the second reference signal may be offset to the reception of the first reference signal by the processing delay time. In one or more examples, the wireless device receives, from the high-altitude node, the first reference signal at time T_{d} and transmits the second reference signal at time T_{d}+T_{Proc} to the radio network node. For example, let T_{Gap}_{₁} be a first time gap between the reception of the first reference signal at the wireless device and the end of the first resource (such as an end time of the first resource), let T_{Gap}_{₂} be a time gap between a start of the second resource (such as a starting time of the second resource) and the transmission of the second reference signal, and let T_{Gap} be a time gap between the first resource and the second resource. The processing delay time may thus be seen as T_{Gap}+T_{Gap}_{₁}+T_{Gap}_{₂}. In one or more example methods, the processing delay time is a pre-determined value. In one or more examples, the processing delay time can be pre-configured by a higher layer, such as by Radio Resource Control (RRC) layer and/or LTE Positioning protocol (LPP) layer. In one or more examples, the processing delay time can be set up in control information, such as configured as a scheduling offset. In other words, the network node may inform the wireless device about the processing delay time via the control information (such as via control signaling). For example, a minimum processing delay can be included in the capability signaling. In one or more example methods, the wireless device can be configured using lower layer control information. For example, the control information indicating the processing delay time may be transmitted to the wireless device using a lower layer, such as Downlink Control Information (DCI) layer. In other words, the wireless device can be configured using a higher layer pre-configuration and/or a combination of a higher layer pre-configuration and lower layer dynamic configurations.

In one or more example methods, transmitting S103 and/or transmitting S104 the first resource configuration and/or the second resource configuration comprises transmitting the first resource configuration and/or the second resource configuration via one or more of: a higher layer signaling (such as, RRC layer and/or LPP layer) and a lower layer signaling (such as, DCI layer).

Optionally, the network node and/or the radio network nodes may be associated with a processing delay time for processing the retransmission of the second reference signal, such as in a DL-based positioning procedure. Such processing delay time associated with the network node and/or the radio network nodes may be shared with the wireless device when the wireless device determines its own position, such as in a DL-based positioning procedure.

In one or more example methods, such as when the network node is the first radio network node, the method 100 comprises receiving S106, from the high-altitude node, the first reference signal transmitted in the first resource. In one or more examples, the network node receives the first reference signal at a certain ToA (such as, time Tₖ of FIG. 3).

The method 100 comprises communicating S108, between the wireless device and the network node, the second reference signal in the second resource. In one or more examples, the second reference signal is transmitted in response to receiving the first reference signal. In other words, the second reference signal may be a retransmitted reference signal and/or reflected reference signal. In one or more examples, the communication of the second reference signal is associated with a time of reception (such as a ToA) of the first reference signal. The method 100 may involve a UL-based positioning procedure and/or a DL-based positioning procedure.

In one or more example methods, the first reference signal and/or the second reference signal is associated with an identifier. In one or more examples, the first reference signal and/or the second reference signal can be identified by an identifier embedded (such as, encoded) in the first reference signal and/or the second reference signal. The identifier may be encoded in the first reference signal and/or the second reference signal explicitly as a code and/or implicitly as a cyclic shift and/or a resource allocation. The cyclic shift may be a cyclic shift of a Zadoff-Chu sequence. In one or more examples, the identifier identifies a source and/or node performing a transmission. For example, the identifier of the first reference signal identifies the high-altitude node. For example, the identifier of the second reference signal identifies the wireless device (such as, UL-based positioning procedure) and/or a network node (such as, DL-based positioning procedure).

In one or more examples, the transmission of first reference signal is associated with a specific (such as a unique) identifier and/or scheduled to a specific time and/or frequency resource (such as to the first resource). Such specific identifier and/or scheduling may enable a mapping of the first reference signal into a 3GPP comb-structure, in which a comb offset may be assigned to the high-altitude node, allowing reduced interference interoperability with other legacy reference signal transmissions that may occur at a same time. In one or more examples, the positioning node may schedule the first resource and transmit, to the high-altitude node via the network node, the first resource configuration to be used for transmission of the first reference signal. In one or more examples, the high-altitude node can receive the first resource configuration via one or more of: a higher layer signaling (such as, RRC layer and/or LPP layer) and a lower layer signaling (such as, DCI layer).

In one or more examples, the transmission of the second reference signal, such as the retransmission of the first reference signal (such as by the wireless device in S108A and/or the network node in S108B) may be uniquely identified by the transmission of the first reference signal from the high-altitude node. In other words, the identifier of the first reference signal may be comprised in the second reference signal. For example, the first reference signal may be detected at a source performing the transmission of the second reference signal as a different propagation time, such as based on a power delay profile (PDP) and/or a resource configuration and/or an identifier.

In one or more example methods, such as when a UL-based positioning procedure is applied, communicating S108 the second reference signal comprises receiving S108A the second reference signal from the wireless device. In one or more examples, the wireless device may transmit the second reference signal in response to receiving the first reference signal from the high-altitude node. In one or more examples, the network node receives, from the wireless device, the second reference signal at a certain ToA (such as at time \tilde{T}ₖ of FIG. 3). Receiving S108A corresponds to the 520 described in relation to FIGS. 3 and 5.

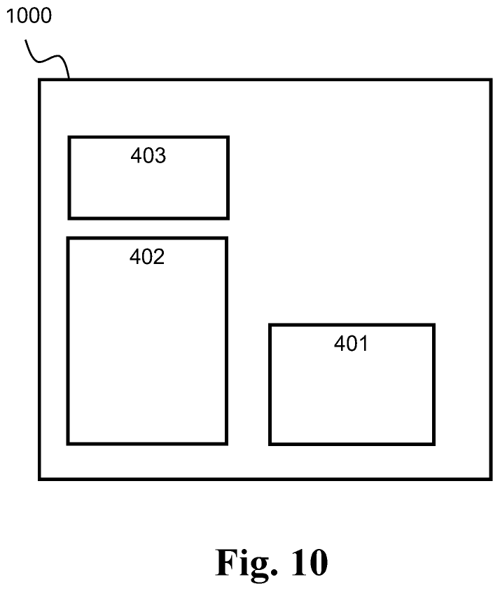

In one or more example methods, the method 100 comprises determining S110, based on the first reference signal and the second reference signal, reception timing information (this corresponds to the reception timing information 526 of FIG. 6). In one or more example methods, the reception timing information is indicative of one or more of: a time associated with a reception of the first reference signal (such as time Tₖ of FIG. 3), and a time associated with a reception of the second reference signal (such as time \tilde{T}ₖ of FIG. 3). Stated differently, the reception timing information may be indicative of a ToA of the first reference signal and/or the second reference signal. In one or more examples, the time associated with the reception of the first reference signal can be seen as the ToA of the first reference signal which is transmitted by the high-altitude node and received by the network node. In one or more examples, the time associated with the reception of the second reference signal can be seen as the ToA of the second reference signal, such as a retransmitted version of the first reference signal which is retransmitted by the wireless device and received by the network node. In one or more examples, the reception timing information is a measurement report indicative of the ToAs and/or the time difference between the reception of the ToAs of the first reference signal and/or the second reference signal. In one or more examples, the network node stores and/or records the time associated with the reception of the first reference signal and/or the time associated with the reception of the second reference signal in a memory circuitry (such as memory circuitry 401 of FIG. 10).

In one or more example methods, such as when the network node is a first radio network node, the method 100 comprises transmitting S112, to the positioning node, the reception timing information. In one or more examples, the positioning node determines, based on the reception timing information, the position of the wireless device, such as the altitude of the wireless device. For example, the positioning node determines a z-coordinate associated with the position of the wireless device in a 3D space. In one or more examples, the positioning node determines, based on the reception timing information, time differences, such as a first time difference tₖ and a second time difference \tilde{t}ₖ, as disclosed in relation to FIG. 3. The first time difference tₖ can be seen as the difference between the time associated with the reception of the first reference signal Tₖ₊₁ at the network node and a reference time T₁ associated with the reception of the first reference signal at a reference radio network node. The second time difference \tilde{t}ₖ can be seen as the difference between the time associated with the reception of the second reference signal \tilde{T}ₖ at the network node and a reference time \tilde{T}₁ associated with the reception of the second reference signal at the reference radio network node. The reference radio network node can be any radio network node participating in the UL-based positioning procedure, such as one or more of the radio network nodes 400 of FIGS. 1-6. The reference times T₁, \tilde{T}₁ enable synchronization between the radio network nodes participating in the UL-based positioning procedure.

In one or more example methods, such as when a DL-based positioning procedure is applied, communicating S108 the second reference signal comprises transmitting S108B, to the wireless device, the second reference signal. In one or more examples, such as when the network node, such as the first radio network node 400A, performs a transmission of the second reference signal, such as a retransmission of the first reference signal, to the wireless device. In one or more example methods, the second reference signal is transmitted in response to the network node receiving the first reference signal from the high-altitude node. Transmitting S108B corresponds to 514 illustrated in FIG. 6.

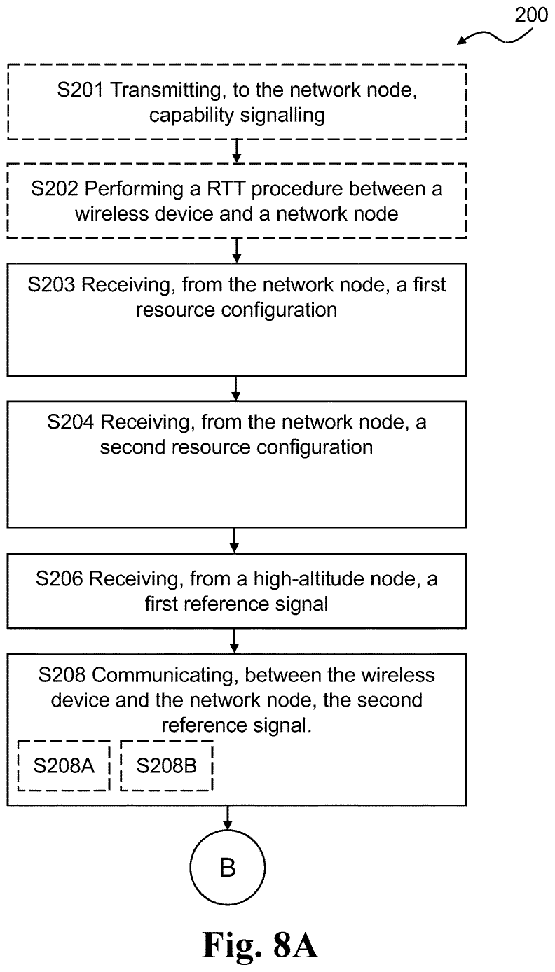

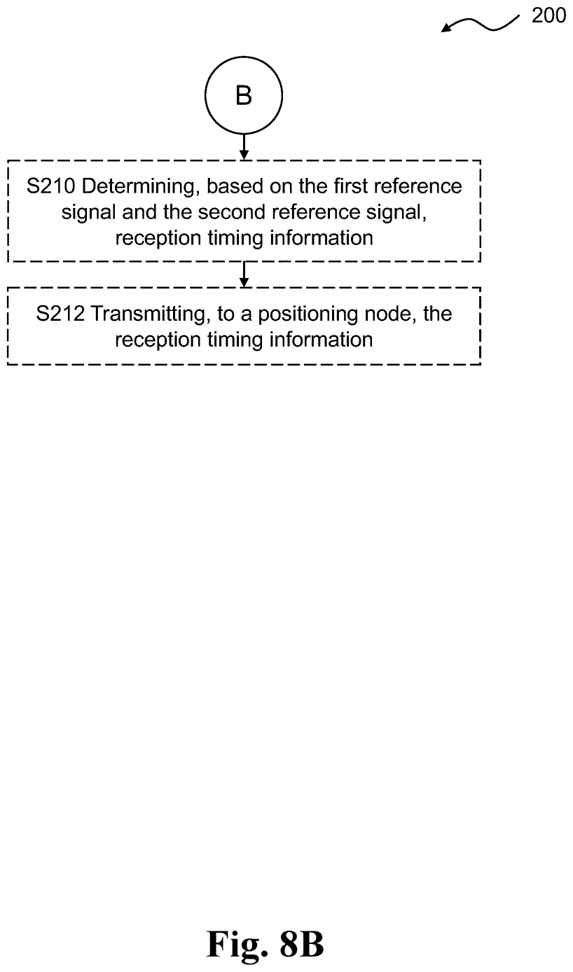

FIGS. 8A-8B show a flow-chart illustrating an example method 200, performed by a wireless device, for positioning of the wireless device, according to this disclosure. The wireless device is the wireless device disclosed herein, such as device 300 of FIGS. 1-4, and FIGS. 6-7, and FIG. 11. The wireless device 300 may in one or more examples be an elevated wireless device, such as a mobile device and/or a UAV.

In one or more example methods, the method comprises transmitting S201, to the network node, capability signaling indicative of a capability of the wireless device to support the communication of the second reference signal in the second resource. In one or more example methods, the capability signaling is indicative of a processing delay time associated with a delay of the wireless device in processing transmission of the second reference signal. In one or more examples, the capability signaling can include information indicative of frequency band combinations of the first and/or second resource. For example, the transmission of the first reference signal and the second reference signal can be performed in different frequency bands. In other words, the first reference signal can be transmitted in a frequency band different from the transmission of the second frequency band. Transmitting S201 corresponds to receiving S101 of FIGS. 7A-7B.

In one or more example methods, the method 100 comprises performing S202 a round-trip-time, RTT, procedure between the wireless device and the network node. Performing S202 corresponds to performing S102 of FIGS. 7A-7B.

The method 200 comprises receiving S203, from a network node, a first resource configuration indicative of a first resource to be used for reception of a first reference signal (such as the first reference signal 512 of FIGS. 5-6) transmitted by a high-altitude node. In one or more example methods, the first resource configuration is received via one or more of: a higher layer signaling and a lower layer signaling. In one or more example methods, the first reference signal and/or the second reference signal is associated with an identifier. In one or more examples, receiving S203 the first resource configuration corresponds to transmitting S103 of FIGS. 7A-7B.

The method 200 comprises receiving S204, from the network node, a second resource configuration. The second resource configuration is indicative of a second resource to be used for communication of a second reference signal (such as the second reference signal 514 of FIGS. 5-6), wherein the communication, such as reception and/or transmission, of the second signal is triggered by the reception of the first reference signal. In one or more example methods, the second resource configuration is indicative of the ToA of the first reference signal. In one or more example methods, the second resource configuration comprises information indicative of the processing delay time T_{Proc} value. In one or more example methods, the second resource configuration is received via one or more of: a higher layer signaling and a lower layer signaling. In one or more examples, receiving S204 corresponds to transmitting S104 of FIGS. 7A-7B.

The method 200 comprises receiving S206, from the high-altitude node, the first reference signal in the first resource. In one or more examples, the wireless device receives the first reference signal at a certain ToA (such as, time T_{d} of FIG. 3). In one or more examples, the positioning node may schedule the first resource and transmit, to the high-altitude node via a scheduling network node (such as, network node 400A of FIGS. 1-6 and FIG. 10), the first resource configuration to be used for transmission of the first reference signal. The high-altitude node may be configured to transmit the first reference signal using the first resource. In one or more examples, the high-altitude node can be configured and/or scheduled by a terrestrial node, such as another scheduling network node different from the scheduling network node. In one or more examples, the transmission of the first reference signal requires to be periodically scheduled and/or scheduled on-demand. In one or more examples, the transmission of the first reference signal is scheduled and placed in measurement gaps, to enable the wireless device to receive the first reference signal with other measurements. For example, in case the wireless device moves around such as moves outside a network cell, the second resource may have to be rescheduled to account for a new set of radio network nodes, and a reconfigured second resource configuration may be transmitted to the wireless device.

The method 200 comprises communicating S208, between the wireless device and the network node, the second reference signal in the second resource. Communicating S208 corresponds to communicating S108 performed by the network node in FIGS. 7A-7B. In one or more example methods, communicating S208 the second reference signal comprises transmitting S208A, to the network node, the second reference signal. In one or more examples, transmitting S208A the second reference signal comprises performing a retransmission of the first reference signal to the network node. In one or more examples, the wireless device performs a retransmission of the first reference signal to a plurality of network nodes (such as, network nodes 400 of FIGS. 1-6, FIG. 10, and FIG. 12). In one or more examples, the wireless device receives the first reference signal at a certain ToA (such as, time T_{d} of FIG. 3). In one or more examples, the wireless device transmits, to the network node, the second reference signal at a certain time-of-departure, ToD (such as, time T_{d}+T_{Proc} of FIG. 3). In one or more examples, the wireless device transmits, to the network node and/or the plurality of network nodes, the second reference signal at a certain time-of-departure, ToD (such as, time T_{d}+T_{Proc} of FIG. 3). In one or more examples, the present technique provides an UL-based positioning procedure. In one or more examples, the UL-based positioning procedure is illustrated in FIGS. 3 and 5. Transmitting S208A corresponds to receiving S108A performed by the network node in FIGS. 7A-7B.

In one or more example methods, communicating S208 the second reference signal comprises receiving S208B, from the network node, the second reference signal. In one or more examples, the network node and/or the plurality of network nodes transmit the second reference signal, such as performs a retransmission of the first reference signal, to the wireless device. This corresponds to the DL-based positioning procedure such as illustrated in FIG. 6. Receiving S208B corresponds to transmitting S108B of FIGS. 7A-7B.

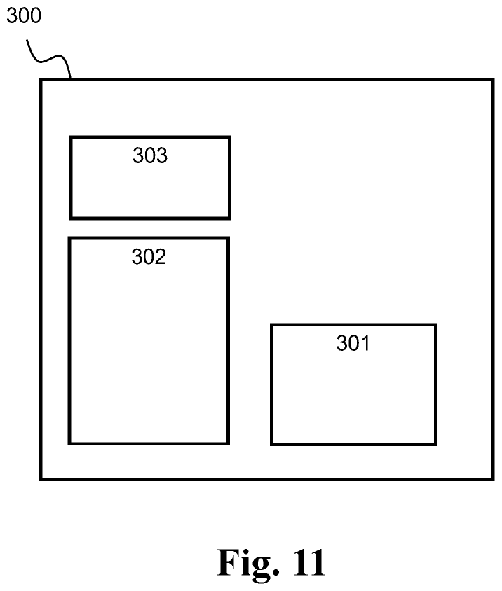

In one or more example methods, the method 200 comprises determining S210, based on the first reference signal and the second reference signal, reception timing information. In one or more example methods, the reception timing information indicative of one or more of: a time associated with a reception of the first reference signal (such as, time T_{d} of FIG. 3), and a time associated with a reception of the second reference signal (such as, time T_{d}+T_{Proc}_{_{NN}}). Stated differently, the reception timing information may be indicative of a ToA of the first reference signal and/or the second reference signal. In one or more examples, the time associated with the reception of the first reference signal can be seen as the ToA of the first reference signal which is transmitted by the high-altitude node and received by the wireless device. In one or more examples, the time associated with the reception of the second reference signal can be seen as the ToA of the second reference signal, such as a retransmitted version of the first reference signal which is retransmitted by the network node and/or the plurality of network nodes and received by the wireless device. In one or more examples, the wireless device stores the time associated with the reception of the first reference signal and/or the time associated with the reception of the second reference signal in memory circuitry (such as, memory circuitry 301 of FIG. 11). In one or more examples, T_{Proc}_{_{NN}} may be indicative of a processing delay time associated with a delay in processing communication of the second reference signal by the network node and/or the plurality of network nodes. The positioning node may have access to such processing delay time (such as, a reaction time). Optionally, the plurality of network nodes can inform the positioning node about such processing delay time.

In one or more example methods, the method 200 comprises transmitting S212, to a positioning node, the reception timing information. In one or more examples, the method 200 comprises transmitting, to the positioning node, the reception timing information via a radio network node, such as a radio network node configured to serve the wireless device. In one or more examples, the positioning node determines, based on the reception timing information, the position of the wireless device, such as the altitude of the wireless device. For example, the positioning node may have received reception timing information determined by the plurality of radio network nodes participating in the positioning of the wireless device, such as reception timing information indicative of a time associated with a reception of the first reference signal and/or a time of performing the transmission of the second reference signal. In one or more examples, the positioning node determines, based on the reception timing information associated with the plurality of network nodes and the reception timing information associated with the wireless device, time differences associated with the time associated with the reception of the first reference signal (such as, by the wireless device and the plurality of network nodes) and/or the time associated with the reception of the second reference signal (such as, by the wireless device). The time differences may be indicative of a time duration between the ToAs of the first reference signal and (possibly multiple) second reference signal(s). The time difference may be proportional to the LoS distance to a specific node. In case there are multiple radio network nodes, the wireless device may be positioning (in xy plane) based on the respective time difference associated with each radio network node. When the distance is known, the time difference between receiving the first reference signal at each radio network node and receiving the first reference signal at the wireless device can be computed, for example by taking the processing delay time into account. The time difference between receiving the first reference signal at each radio network node and receiving the first reference signal at the wireless device may be proportional to the relative elevation.

Optionally, the plurality of radio network nodes can transmit, to the wireless device, reception timing information indicative of a time associated with a reception of the first reference signal. The wireless device may determine, based on the reception timing information transmitted by the plurality of radio network nodes and its own reception timing information, its position. Stated differently, the wireless device may perform a positioning measurement. In one or more examples, the wireless device may transmit, to the positioning node via the network node serving the wireless device, the determined position. For example, the wireless device can determine a relative position in which an absolute position may be unknown to the system.

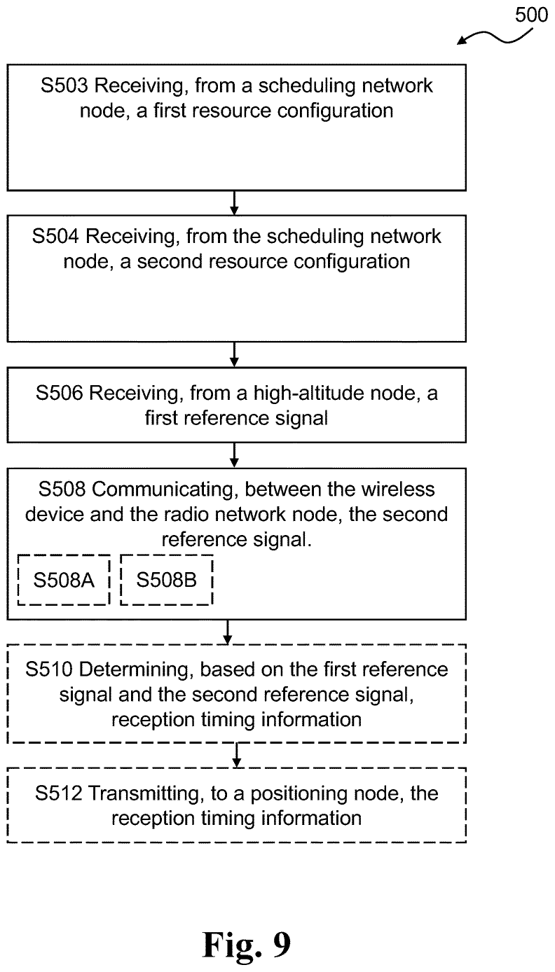

FIG. 9 shows a flow-chart illustrating an example method 500, performed by a radio network node according to this disclosure, for enabling positioning of a wireless device. The radio network node is the radio network node disclosed herein, such as radio network node 400B of FIGS. 1-6, and FIG. 12. The radio network node may be a radio network node participating in the positioning of the wireless device, such as via UL and/or DL positioning. In one or more examples, the radio network node is a network node that receives, from a scheduling network node, information indicative of allocation of resources for reception of the first reference signal and communication of the second reference signal. The radio network node can be seen as a radio network node that is configured to participate in a positioning procedure of the wireless device.

The method 500 comprises receiving S503, from a scheduling network node, such as the first radio network node 400A or the positioning node 600, a first resource configuration indicative of a first resource to be used for reception of the first reference signal transmitted by a high-altitude node. In one or more example methods, the first resource configuration is received via one or more of: a higher layer signaling and a lower layer signaling. Receiving S503 is similar to S103 and corresponds to S103A of FIGS. 7A-7B.

The method 500 comprises receiving S504, from the scheduling network node, a second resource configuration. The second resource configuration is indicative of a second resource to be used for communication of a second reference signal triggered by and/or being indicative of the reception of the first reference signal, such as the time of reception of the first reference signal. In one or more example methods, the second resource configuration comprises information indicative of a processing delay time associated with a delay in processing communication of the second reference signal. In one or more example methods, the transmission of the second reference signal is offset to the reception of the first reference signal by the processing delay time. In one or more example methods, the processing delay time is a pre-determined value. In one or more example methods, the second resource configuration is received via one or more of: a higher layer signaling and a lower layer signaling. Receiving S504 corresponds to S104 of FIGS. 7A-7B.

In one or more example methods, the first reference signal and/or the second reference signal is associated with an identifier.

The method 500 comprises receiving S506, from the high-altitude node, the first reference signal in a first resource. Receiving S506 corresponds to S106 of FIGS. 7A-7B.

The method 500 comprises communicating S508, between the wireless device and the radio network node, the second reference signal in a second resource. Communicating S508 corresponds to communicating S108 of FIGS. 7A-7B.

In one or more example methods, communicating S508 the second reference signal comprises receiving S508A, from a wireless device, the second reference signal. Receiving S508A corresponds to receiving S108A of FIGS. 7A-7B.

In one or more example methods, communicating S508 the second reference signal comprises transmitting S508B, to the wireless device, the second reference signal. Transmitting S508B corresponds to S108B of FIGS. 7A-7B.

In one or more example methods, the method 500 comprises determining S510, based on the first reference signal and the second reference signal reception timing information. In one or more example methods, the reception timing information is indicative of one or more of: a time associated with a reception of the first reference signal, and a time associated with a reception of the second reference signal. Determining S510 corresponds to determining S110 of FIGS. 7A-7B.

In one or more example methods, the method 500 comprises transmitting S512, to a positioning node, the reception timing information. Transmitting S512 corresponds to transmitting S112 of FIGS. 7A-7B.

FIG. 10 shows a block diagram of an example network node 1000 according to the disclosure. The network node 1000 comprises memory circuitry 401, processor circuitry 402, and a wireless interface 403. The network node 1000 may be configured to perform any of the methods disclosed in FIGS. 7A-7B. In other words, the network node 1000 may be configured to enable positioning of a wireless device. The network node 1000 may be one or more of the first radio network node 400A and the positioning node 600 disclosed herein.

The network node 1000 is configured to communicate with a wireless device and a high-altitude node, such as the wireless device and the high-altitude node disclosed herein, using a wireless communication system.

The network node 1000 is configured to transmit (such as, via the wireless interface 403), to the wireless device, a first resource configuration indicative of a first resource to be used for reception of a first reference signal transmitted by a high-altitude node.

The network node 1000 is configured to transmit (such as, via the wireless interface 403), to the wireless device, a second resource configuration indicative of a second resource to be used for communication of a second reference signal triggered by the reception and/or being indicative of the reception of the first reference signal, such as the time of reception of the first reference signal.

The network node 1000 is configured to receive (such as, via the wireless interface 403), from the high-altitude node, the first reference signal transmitted in the first resource.

The network node 1000 is configured to communicate (such as, via the wireless interface 403), between the wireless device and the network node, the second reference signal in the second resource.

The wireless interface 403 is configured for wireless communications via a wireless communication system, such as a 3GPP system, such as a 3GPP system supporting one or more of: New Radio, NR, Long Term Evolution, LTE, Narrow-band IoT, NB-IOT, and Long Term Evolution-enhanced Machine Type Communication, LTE-M, and 3GPP system operated in licensed bands or unlicensed bands.

Processor circuitry 402 is optionally configured to perform any of the operations disclosed in FIGS. 7A-7B (such as any one or more of: S101, S102, S103, S103A, S104, S106, S108, S108A, S108B, S110, and S114). The operations of the network node 1000 may be embodied in the form of executable logic routines (for example, lines of code, software programs, etc.) that are stored on a non-transitory computer readable medium (for example, memory circuitry 401) and are executed by processor circuitry 402.

Furthermore, the operations of the network node 1000 may be considered a method that the network node 1000 is configured to carry out. Also, while the described functions and operations may be implemented in software, such functionality may also be carried out via dedicated hardware or firmware, or some combination of hardware, firmware and/or software.

Memory circuitry 401 may be one or more of: a buffer, a flash memory, a hard drive, a removable media, a volatile memory, a non-volatile memory, a random access memory, RAM, and any other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 10). Memory circuitry 401 is considered a non-transitory computer readable medium.

Memory circuitry 401 may be configured to store one or more of a first resource configuration, a second resource configuration, a first reference signal, a second reference signal, reception timing information, a processing delay time, an identifier, capability signaling in a part of the memory.

FIG. 11 shows a block diagram of an example wireless device 300 according to the disclosure. The wireless device 300 comprises memory circuitry 301, processor circuitry 302, and a wireless interface 303. The wireless device 300 may be configured to perform any of the methods disclosed in FIGS. 8A-8B. In other words, the wireless device 300 may be configured to enable positioning of the wireless device 300. In one or more examples, the wireless device 300 is configured to determine its position.

The wireless device 300 is configured to communicate with a network node, such as one or more radio network nodes, and a high-altitude node, such as the network node 1000, the radio network nodes 400 and the high-altitude node disclosed herein, using a wireless communication system.

The wireless device 300 is configured to receive (such as, via the wireless interface 303), from a network node, a first resource configuration indicative of a first resource to be used for reception of a first reference signal transmitted by a high-altitude node.

The wireless device 300 is configured to receive (such as, via the wireless interface 303), from the network node, a second resource configuration indicative of a second resource to be used for communication of a second reference signal triggered by the reception of the first reference signal.

The wireless device 300 is configured to receive (such as, via the wireless interface 303), from the high-altitude node, the first reference signal in the first resource.

The wireless device 300 is configured to communicate (such as, via the wireless interface 303), between the wireless device and the network node, the second reference signal in the second resource.

The wireless interface 303 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

The wireless device 300 is optionally configured to perform any of the operations disclosed in FIGS. 8A-8B (such as any one or more of: S201, S202, S203, S204, S206, S208, S208A, S208B, S210, and S212). The operations of the wireless device 300 may be embodied in the form of executable logic routines (for example, lines of code, software programs, etc.) that are stored on a non-transitory computer readable medium (for example, memory circuitry 301) and are executed by processor circuitry 302.

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of: a buffer, a flash memory, a hard drive, a removable media, a volatile memory, a non-volatile memory, a random-access memory, RAM, and any other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 11). Memory circuitry 301 is considered a non-transitory computer readable medium.

Memory circuitry 301 may be configured to store one or more of a first resource configuration, a second resource configuration, a first reference signal, a second reference signal, reception timing information, a processing delay time, and an identifier in a part of the memory.

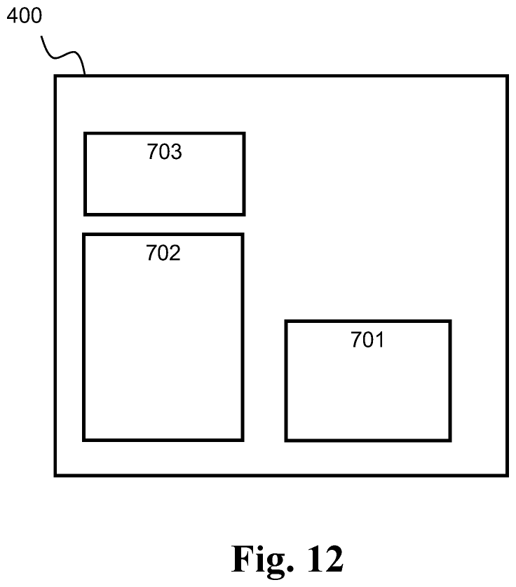

FIG. 12 shows a block diagram of an example radio network node 400 according to the disclosure. The radio network node 400 comprises memory circuitry 701, processor circuitry 702, and a wireless interface 703. The radio network node 400 may be configured to perform any of the methods disclosed in FIG. 9. In other words, the radio network node 400 may be configured to enable positioning of a wireless device.

The radio network node 400 is configured to communicate with a scheduling network node, a high-altitude node, and a wireless device, such as the scheduling network node, the high-altitude node, and the wireless device disclosed herein, using a wireless communication system.

The radio network node 400 is configured to receive (such as, via the wireless interface 703), from a scheduling network node, a first resource configuration indicative of a first resource to be used for reception of a first reference signal transmitted by a high-altitude node.

The radio network node 400 is configured to receive (such as, via the wireless interface 703), from the network node, a second resource configuration indicative of a second resource to be used for communication of a second reference signal triggered by the reception of the first reference signal.

The radio network node 400 is configured to receive (such as, via the wireless interface 703), from the high-altitude node, the first reference signal in the first resource.

The radio network node 400 is configured to communicate (such as, via the wireless interface 703), between the wireless device and the radio network node, the second reference signal in the second resource.

The wireless interface 703 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

The radio network node 400 is optionally configured to perform any of the operations disclosed in FIG. 9 (such as any one or more of: S503, S504, S506, S508, S508A, S508B, S510, and S512). The operations of the radio network node 400 may be embodied in the form of executable logic routines (for example, lines of code, software programs, etc.) that are stored on a non-transitory computer readable medium (for example, memory circuitry 701) and are executed by processor circuitry 702.

Furthermore, the operations of the radio network node 400 may be considered a method that the radio network node 400 is configured to carry out. Also, while the described functions and operations may be implemented in software, such functionality may also be carried out via dedicated hardware or firmware, or some combination of hardware, firmware and/or software.

Memory circuitry 701 may be one or more of: a buffer, a flash memory, a hard drive, a removable media, a volatile memory, a non-volatile memory, a random-access memory, RAM, and any other suitable device. In a typical arrangement, memory circuitry 701 may include a non-volatile memory for long term data storage and a volatile memory that functions as system memory for processor circuitry 702. Memory circuitry 701 may exchange data with processor circuitry 702 over a data bus. Control lines and an address bus between memory circuitry 701 and processor circuitry 702 also may be present (not shown in FIG. 12). Memory circuitry 701 is considered a non-transitory computer readable medium.

Memory circuitry 701 may be configured to store one or more of a first resource configuration, a second resource configuration, a first reference signal, a second reference signal, reception timing information, a processing delay time, and an identifier in a part of the memory.

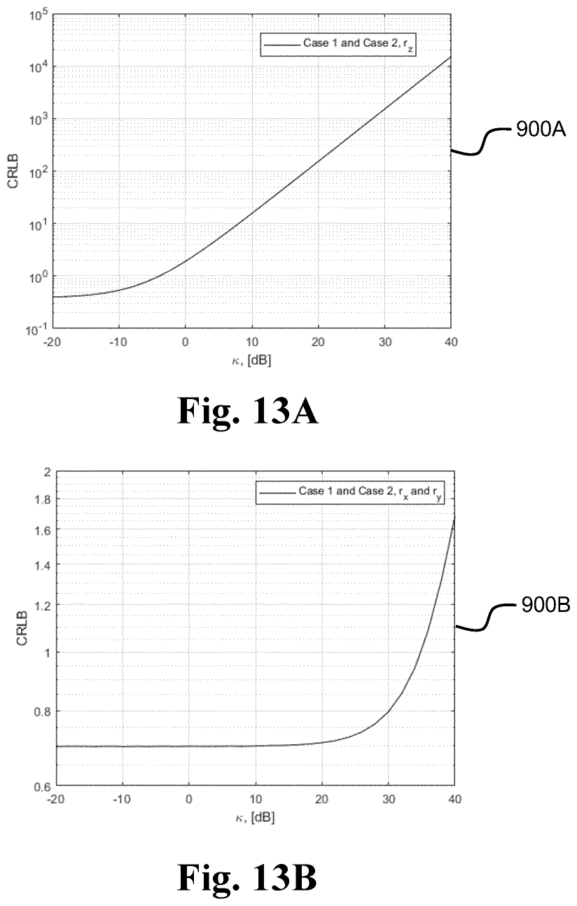

FIGS. 13A-13B are graphs 900A, 900B illustrating example performances of the positioning of a wireless device according to this disclosure. FIGS. 13A-13B provide numerical results of Cramer-Rao bounds for the disclosed technique. The numerical results are supported by theoretical derivations disclosed in the following.

Let To be a reference time defined such that, for example, Tₖ=T₀+D_{s,k}/c+n_{s,k}, where D_{s,k} denotes a distance between a high-altitude node (such as, high-altitude node 800) and a network node k (such as, radio network nodes 400A, 400B), n_{s,k} denotes Gaussian noise, and c denotes the speed of light. For example, Tₖ denotes a time associated with a reception of a first reference signal transmitted by the high-altitude node at the network node k. A time difference associated with reception of a first reference signal, such as tₖ=Tₖ₊₁−T₁, may be expressed as,

$${t}_{k} = {T}_{0} + \frac{{D}_{s , k + 1}}{c} + {n}_{s , k + 1} - {T}_{0} - \frac{{D}_{s , 1}}{c} - {n}_{s , 1} = \frac{{D}_{s , k + 1} - {D}_{s , 1}}{c} + {n}_{s , k + 1} - {n}_{s , 1} \qquad ( 1 )$$

where tₖ denotes a time difference between a time associated with the reception of the first reference signal at network node k+1 and a time associated with the reception of the first reference signal at a first network node (such as, network node 1).

A conversion of tₖ into distance measures may be expressed as,

$${d}_{k} = c {t}_{k} = {D}_{s , k + 1} - {D}_{s , 1} + {η}_{s , k + 1} - {η}_{s , 1} \qquad ( 2 )$$

where the variance of η_{s,k}, with k=1 . . . K, is No.

Likewise, T_{d}=T₀+D_{s,d}/c+n_{s,d} denotes a time associated with the reception of the first reference signal transmitted by the high-altitude node at the wireless device, where D_{s,d} denotes the distance between the high-altitude node and the wireless device, and n_{s,d} denotes Gaussian noise. A time associated with a reception of a second reference signal at the network node k (such as, with the second reference signal being transmitted by the wireless device to the network node k) may be expressed as,

$${\tilde{T}}_{k} = {T}_{0} + \frac{{D}_{s , d}}{c} + {n}_{s , d} + \frac{{D}_{d , k}}{c} + {n}_{d , k} \qquad ( 3 )$$

where D=_{d,k} denotes the distance between the wireless device and network node k. A time difference associated with reception of the second reference signal may be expressed as,

$${\tilde{t}}_{k} = {\tilde{T}}_{k} - {T}_{1} = {T}_{0} + \frac{{D}_{s , d}}{c} + {n}_{s , d} + \frac{{D}_{d , k}}{c} + {n}_{d , k} - {T}_{0} - \frac{{D}_{s , 1}}{c} - {n}_{s , 1} \qquad ( 4 )$$

where \tilde{t}ₖ denotes a time difference between a time associated with the reception of the second reference signal at network node k and a time associated with the reception of the second reference signal at a first network node (such as, network node 1).

A conversion of \tilde{t}ₖ into distance measures may be expressed as,

$${\tilde{d}}_{k} = {\tilde{t}}_{k} c = {D}_{s , d} + {D}_{d , k} - {D}_{s , 1} + {η}_{s , d} + {η}_{d , k} - {η}_{s , 1} \qquad ( 5 )$$

where η_{s,d} has variance N₁ and η_{d,k}, with k=1 . . . K, has variance N₂. By collecting all the observations into a single vector,

$$( 6 )$$

$$d = [ \begin{matrix}{d}_{1} \\ ⋮ \\ {d}_{K - 1} \\ {\tilde{d}}_{1} \\ ⋮ \\ {\tilde{d}}_{K}\end{matrix} ] = [ \begin{matrix}{D}_{s , 2} \\ ⋮ \\ {D}_{s , K} \\ {D}_{d , 1} \\ ⋮ \\ {D}_{d , K}\end{matrix} ] + [ \begin{matrix}0 \\ ⋮ \\ 0 \\ 1 \\ ⋮ \\ 1\end{matrix} ] {D}_{s , d} - {1}_{2 K - 1} {D}_{s , 1} + [ \begin{matrix}{η}_{s , 2} \\ ⋮ \\ {η}_{s , K} \\ {η}_{d , 1} \\ ⋮ \\ {η}_{d , K}\end{matrix} ] + [ \begin{matrix}0 \\ ⋮ \\ 0 \\ 1 \\ ⋮ \\ 1\end{matrix} ] {η}_{s , d} - {1}_{2 K - 1} {η}_{s , 1}$$

where 1_{N} denotes an all-ones N×1 vector. Let w denote noise terms, which may be expressed as,

$$w = [ \begin{matrix}{η}_{s , 2} \\ ⋮ \\ {η}_{s , K} \\ {η}_{d , 1} \\ ⋮ \\ {η}_{d , K}\end{matrix} ] + [ \begin{matrix}0 \\ ⋮ \\ 0 \\ 1 \\ ⋮ \\ 1\end{matrix} ] {η}_{s , d} - {1}_{2 K - 1} {η}_{s , 1} \qquad ( 7 )$$

The covariance of the noise w may be expressed as,

$${R}_{w w} = [ \begin{matrix}{I}_{K - 1} {N}_{0} & {0}_{K - 1 , K} \\ {0}_{K , K - 1} & {I}_{K} {N}_{2}\end{matrix} ] + [ \begin{matrix}{0}_{K - 1} & {0}_{K - 1 , K} \\ {0}_{K , K - 1} & {1}_{K , K} {N}_{1}\end{matrix} ] + {1}_{2 K - 1 , 2 K - 1} {N}_{0} \qquad ( 8 )$$

where IN denotes an identity matrix of dimension N, 0_{M,N} denotes a N×M all-zero matrix, 0_{N} denotes a shorthand notation for 0_{N,N}, and 1_{N,N} denotes an all-ones N×N matrix. Let μ(θ) be expressed as,

$$μ ( θ ) = [ \begin{matrix}{D}_{s , 2} \\ ⋮ \\ {D}_{s , K} \\ {D}_{d , 1} \\ ⋮ \\ {D}_{d , K}\end{matrix} ] + [ \begin{matrix}0 \\ ⋮ \\ 0 \\ 1 \\ ⋮ \\ 1\end{matrix} ] {D}_{s , d} - {1}_{2 K - 1} {D}_{s , 1} \qquad ( 9 )$$

where θ denotes a vector collecting the unknown parameter. In other words, θ includes the position of the wireless device. The vector of observations may be expressed as d=μ(θ)+w. The Fisher information may now be, straightforwardly, computed as

$${[ I ( θ ) ]}_{i j} = \frac{\partial {μ}^{T} ( θ )}{\partial {θ}_{i}} {R}_{w w}^{- 1} \frac{\partial μ ( θ )}{\partial {θ}_{j}} \qquad ( 10 )$$

Let r=[rₓ r_{y} r_{z}]^{T} be the coordinates of the wireless device's position, s=[sₓ s_{y} s_{z}]^{T} be the coordinates of the high-altitude node's position, and gₖ=[g_{k,x} g_{k,y} g_{k,z}]^{T} be the coordinates of the network node k's position.

The present disclosure may provide techniques for determining the position of the wireless device, such as θ=[rₓ, r_{y}, r_{z}], when the high-altitude node's position is known. For example, the respective CRLB can be calculated using the following vector,

$$\frac{\partial μ ( θ )}{\partial {r}_{v}} = [ \begin{matrix}0 \\ ⋮ \\ 0 \\ \frac{( {r}_{v} - {g}_{1 , v} )}{{D}_{d , 1}} \\ ⋮ \\ \frac{( {r}_{v} - {g}_{K , v} )}{{D}_{d , K}}\end{matrix} ] + [ \begin{matrix}0 \\ ⋮ \\ 0 \\ 1 \\ ⋮ \\ 1\end{matrix} ] \frac{( {r}_{v} - {s}_{v} )}{{D}_{s , d}} , v ∈ \{ x , y , z \} \qquad ( 11 )$$

The present disclosure may provide techniques for determining the position of a wireless device when the position of a high-altitude node is in the far-field, but at unknown direction. The present disclosure may provide techniques for determining the position of a wireless device when using a high-altitude node that is located in the far-field with unknown direction. The position of the satellite may be expressed as,

$$[ \begin{matrix}{s}_{x} \\ {s}_{y} \\ {s}_{z}\end{matrix} ] = {\underbrace{[ \begin{matrix}sin ( φ ) sin ( ϕ ) \\ sin ( φ ) cos ( ϕ ) \\ cos ( φ )\end{matrix} ]}}_{e} L , L >> 1 \qquad ( 12 )$$

where φ and φ denotes elevation and azimuth angles, respectively. By invoking elementary linear algebra, it can be verified that,

$${μ}_{∞} ( θ ) = {lim}_{L \to ∞} μ ( θ ) = [ \begin{matrix}{e}^{T} ( {g}_{2} - {g}_{1} ) \\ ⋮ \\ {e}^{T} ( {g}_{K} - {g}_{1} ) \\ 0 \\ ⋮ \\ 0\end{matrix} ] + [ \begin{matrix}0 \\ ⋮ \\ 0 \\ {D}_{d , 1} \\ ⋮ \\ {D}_{d , K}\end{matrix} ] + [ \begin{matrix}0 \\ ⋮ \\ 0 \\ 1 \\ ⋮ \\ 1\end{matrix} ] {e}^{T} ( d - {g}_{1} ) \qquad ( 13 )$$

For example, the Fisher information can be obtained by taking differentials of μ_{∞}(θ).

In one or more examples, the position of the wireless device can be determined using a maximum likelihood estimation (MLE) technique, in which likelihood functions can be deduced based on the above equations.

The wireless device (such as, wireless device 300 and/or UAV 300A) and a plurality of radio network nodes, such as K radio network nodes (such as, radio network nodes 400), may be located in a cell (such as cell 16 of FIGS. 2A-2B. For example, the cell radius (such as, cell 16 of FIGS. 2A-2B) is 1000m. For example, K=3 radio network nodes are placed randomly within discs of radius 50 m, with the centers of such discs being uniformly placed at the edge of the cell.

For example, the position of the high-altitude node is located uniformly in the range [1900,2100] km, and both sₓ and s_{y} abide a normal distribution with a zero mean (such as, on average, right above the center of the cell) and a standard deviation of 100 km.

For example, the elevation and/or altitude and/or height of the wireless device, such as denoted as r_{z}, is uniform in the range [10,100] m and rₓ, r_{y} are both uniformly distributed in a disc of radius 300 m, with such disc being centered in the cell.

For example, the time associated with a reception of the first reference signal at a radio network node (such as, time Tₖ) may have a precision denoted by No, such as when the time associated with the reception of the first reference signal at the radio network node is converted into a distance by cTₖ. For example, the time associated with a reception of the first reference signal at the wireless device (such as, time T_{d}) may have a precision denoted by N₁, such as when the time associated with the reception of the first reference signal at the wireless device is converted into a distance by cT_{d}. For example, the time associated with a reception of the second reference signal at the radio network node (such as, time \tilde{T}ₖ) may have a precision denoted by N₂, such as when the time associated with the reception of the second reference signal at the radio network node is converted into a distance by c\tilde{T}ₖ). For example, N₀, N₁, N₂ relate to distances, such as to times converted into distances. In other words, No, N₁, N₂ may indicate the variance of the error in the respective distances. Such precision may be illustrated by the previous theoretical derivations.

Results of the Cramer-Rao Lower Bound (CRLB) are illustrated in FIGS. 13A-13B. For example, the CRLB results are reported as a function of κ as N₁=N₀=κN₂. For example, the CRLBs become proportional to N₂, wherefore N₂ have been normalized to N₂=1. In other words, the x-axis may represent the ratio No/N₂. The x-axis represents the precision of the time measurements associated with the reception of the second reference signal compared to the precision of the time measurements for the reception of the first reference signal, such as both at the radio network nodes and the wireless device. For example, the x-axis may indicate that the time associated with the reception of the second reference signal is estimated k times worse than the time associated with the reception of the first reference signal. The CRLB may be seen as an upper bound to precision of the determination (such as, estimation) of the wireless device's position. The y-axis represents a variance associated with an estimation of the position of the wireless device (such as of the coordinates rₓ, r_{y}, r_{z}), with such variance given in terms of an estimation error associated with the reception time of the first reference signal, such as given by a corresponding distance.

FIG. 13A illustrates a CRLB associated with the determination of the z-coordinate of the wireless device (such as, coordinate r_{z}) when the high-altitude node's position is known referred herein as Case 1. FIG. 13A illustrates a CRLB associated with the determination of the z-coordinate of the wireless device (such as, coordinate r_{z}) when the high-altitude node is in the far-field, but at an unknown direction referred herein as Case 2. The CRLB associated the determination of the z-coordinate for Case 1 is overlapped with the CRLB associated the determination of the z-coordinate for associated with Case 2. FIG. 13B illustrates CRLBs associated with the determination of the x and y coordinates of the wireless device (such as, coordinates rₓ, r_{y}) for both Case 1 and Case 2. The CRLB associated the determination of the x and y coordinates for Case 1 is overlapped with the CRLB associated the determination of the x and y coordinates for associated with Case 2.

It can be seen from FIGS. 13A-13B that knowing the high-altitude node's position may not be of high importance when implementing the disclosed technique. For example, the K=3 radio network nodes are capable of estimating the position (such as, at least the direction) of the high-altitude node, when the high-altitude node is located in the far-field.

It can be seen from FIG. 13B that the quality of the positioning in the x-y directions is independent of the quality in the links related to the high-altitude node. For example, an approximation of the CRLB in the z direction, as illustrated in FIG. 13A, may be expressed as,

$$CRLB \approx {N}_{2} ( \frac{2}{5} + \frac{3}{2} κ ) \qquad ( 14 )$$

where N₂ is an arbitrary value.

For example, Equation 14 shows that for a high-altitude node assisted positioning, the quality of the time measurements related to the high-altitude node cannot be worse than those made between the wireless device and the radio network nodes. For example, whenever the noises associated with the reception times (such as, times Tₖ, T_{d}, and \acute{T}ₖ) are of similar strength, such as, κ≈1, the performance is satisfactory as the CRLB is on the same order as the noise between the wireless device and the radio network nodes. The present disclosure provides a technique capable of determining the position of the wireless device in a precise manner and without requiring knowledge of the high-altitude node's position.

Examples of methods and products (network node, radio network node, and wireless device) according to the disclosure are set out in the following items:
Item 1. A method, performed by a network node, for enabling positioning of a wireless device, the method comprising:
   transmitting (S103), to the wireless device, a first resource configuration indicative of a first resource to be used for reception of a first reference signal transmitted by a high-altitude node;
   transmitting (S104), to the wireless device, a second resource configuration indicative of a second resource to be used for communication of a second reference signal triggered by the reception of the first reference signal;
   receiving (S106), from the high-altitude node, the first reference signal transmitted in the first resource; and
   communicating (S108), between the wireless device and the network node, the second reference signal in the second resource.
Item 2. The method according to item 1, wherein communicating (S108) the second reference signal comprises receiving (S108A), from the wireless device, the second reference signal.
Item 3. The method according to item 2, wherein the method comprises determining (S110), based on the first reference signal and the second reference signal, reception timing information indicative of one or more of: a time associated with a reception of the first reference signal, and a time associated with a reception of the second reference signal.
Item 4. The method according to item 3, wherein the method comprises transmitting (S112), to a positioning node, the reception timing information.
Item 5. The method according to item 1, wherein communicating (S108) the second reference signal comprises transmitting (S108B), to the wireless device, the second reference signal.
Item 6. The method according to any of the previous items, wherein the second resource configuration comprises information indicative of a processing delay time associated with a delay in processing communication of the second reference signal.
Item 7. The method according to any of items 5-6, wherein the transmission of the second reference signal is offset to the reception of the first reference signal by the processing delay time.
Item 8. The method according to any of items 6-7, wherein the processing delay time is a pre-determined value.
Item 9. The method according to any of the previous items, wherein transmitting (S103, S104) the first resource configuration and/or the second resource configuration comprises transmitting the first resource configuration and/or the second resource configuration via one or more of: a higher layer signaling and a lower layer signaling.
Item 10. The method according to any of the previous items, wherein the first reference signal and/or the second reference signal is associated with an identifier.
Item 11. The method according to any of the previous items, wherein the method comprises receiving (S101), from the wireless device, capability signaling indicative of a capability of the wireless device to support the communication of the second reference signal in the second resource.
Item 12. The method according to any of the previous items, wherein the capability signaling is indicative of a processing delay time associated with a delay of the wireless device in processing transmission of the second reference signal.
Item 13. The method according to any of the previous items, wherein the method comprises performing (S102) a round-trip-time, RTT, procedure between the wireless device and the network node.
Item 14. A method, performed by a wireless device, for positioning the wireless device, the method comprising:
   receiving (S203), from a network node, a first resource configuration indicative of a first resource to be used for reception of a first reference signal transmitted by a high-altitude node;
   receiving (S204), from the network node, a second resource configuration indicative of a second resource to be used for communication of a second reference signal triggered by the reception of the first reference signal;
   receiving (S206), from the high-altitude node, the first reference signal in the first resource; and
   communicating (S208), between the wireless device and the network node, the second reference signal in the second resource.
Item 15. The method according to item 14, wherein communicating (S208) the second reference signal comprises transmitting (S208A), to the network node, the second reference signal.
Item 16. The method according to item 14, wherein communicating (S208) the second reference signal comprises receiving (S208B), from the network node, the second reference signal.
Item 17. The method according to item 16, wherein the method comprises determining (S210), based on the first reference signal and the second reference signal, reception timing information indicative of one or more of: a time associated with a reception of the first reference signal, and a time associated with a reception of the second reference signal.
Item 18. The method according to item 17, wherein the method comprises transmitting (S212), to a positioning node, the reception timing information.
Item 19. The method according to any of items 14-18, wherein the second resource configuration comprises information indicative of a processing delay time associated with a delay in processing communication of the second reference signal.
Item 20. The method according to items 15 and 19, wherein the transmission of the second reference signal is offset to the reception of the first reference signal by the processing delay time.
Item 21. The method according to any of items 19-20, wherein the processing delay time is a pre-determined value.
Item 22. The method according to any of items 14-21, wherein receiving (S203, S204) the first resource configuration and/or the second resource configuration comprises receiving the first resource configuration and/or the second resource configuration via one or more of: a higher layer signaling and a lower layer signaling.
Item 23. The method according to any of items 14-22, wherein the first reference signal and/or the second reference signal is associated with an identifier.
Item 24. The method according to any of items 14-23, wherein the method comprises transmitting (S201), to the network node, capability signaling indicative of a capability of the wireless device to support the communication of the second reference signal in the second resource.
Item 25. The method according to any of items 14-24, wherein the capability signaling is indicative of a processing delay time associated with a delay of the wireless device in processing transmission of the second reference signal.
Item 26. The method according to any of items 14-25, wherein the method comprises performing (S202) a round-trip-time, RTT, procedure between the wireless device and the network node.
   Item 27. A method, performed by a radio network node, for enabling positioning of a wireless device, the method comprising:
   receiving (S503), from a scheduling network node, a first resource configuration indicative of a first resource to be used for reception of a first reference signal transmitted by a high-altitude node;
   receiving (S504), from the scheduling network node, a second resource configuration indicative of a second resource to be used for communication of a second reference signal triggered by the reception of the first reference signal;
   receiving (S506), from the high-altitude node, the first reference signal in a first resource; and
   communicating (S508), between the wireless device and the radio network node, the second reference signal in a second resource.
Item 28. The method according to item 27, wherein communicating (S508) the second reference signal comprises receiving (S508A), from a wireless device, the second reference signal.
Item 29. The method according to item 28, wherein the method comprises determining (S510), based on the first reference signal and the second reference signal, reception timing information indicative of one or more of: a time associated with a reception of the first reference signal, a time associated with a reception of the second reference signal.
Item 30. The method according to item 29, wherein the method comprises transmitting (S512), to a positioning node, the reception timing information.
Item 31. The method according to item 27, wherein communicating (S508) the second reference signal comprises transmitting (S508B), to the wireless device, the second reference signal.
Item 32. The method according to any of items 27-31, wherein the second resource configuration comprises information indicative of a processing delay time associated with a delay in processing communication of the second reference signal.
Item 33. The method according to any of items 31-32, wherein the transmission of the second reference signal is offset to the reception of the first reference signal by the processing delay time.
Item 34. The method according to any of items 32-33, wherein the processing delay time is a pre-determined value.
Item 35. The method according to any of items 27-34, wherein receiving (S503, S504) the first resource configuration and/or the second resource configuration comprises receiving the first resource configuration and/or second resource configuration via one or more of: a higher layer signaling and a lower layer signaling.
Item 36. The method according to any of items 27-35, wherein the first reference signal and/or the second reference signal is associated with an identifier.
Item 37. A network node comprising memory circuitry, processor circuitry, and a wireless interface, wherein the network node is configured to perform any of the methods according to any of items 1-13.
Item 38. A wireless device comprising memory circuitry, processor circuitry, and a wireless interface, wherein the wireless device is configured to perform any of the methods according to any of items 14-26.
Item 39. A radio network node comprising memory circuitry, processor circuitry, and a wireless interface, wherein the radio network node is configured to perform any of the methods according to any of items 27-36.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-13B comprise some circuitries or operations which are illustrated with a solid line and some circuitries, components, features, or operations which are illustrated with a dashed line. Circuitries or operations which are comprised in a solid line are circuitries, components, features, or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional. Other operations that are not described herein can be incorporated in the example operations. For example, one or more additional operations can be performed before, after, simultaneously, or between any of the described operations. Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination.

It is to be noted that the word “comprising” does not necessarily exclude the presence of other elements or steps than those listed. It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value.

The various example methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVDs), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a network node, for enabling positioning of a wireless device, the method comprising:
transmitting, to the wireless device, a first resource configuration indicative of a first resource to be used for reception of a first reference signal transmitted by a high-altitude node;
transmitting, to the wireless device, a second resource configuration indicative of a second resource to be used for communication of a second reference signal triggered by the reception of the first reference signal;
receiving, from the high-altitude node, the first reference signal transmitted in the first resource; and
communicating, between the wireless device and the network node, the second reference signal in the second resource.

2. The method according to claim 1, wherein communicating the second reference signal comprises receiving, from the wireless device, the second reference signal.

3. The method according to claim 2, wherein the method comprises determining, based on the first reference signal and the second reference signal, reception timing information indicative of one or more of: a time associated with a reception of the first reference signal, and a time associated with a reception of the second reference signal.

4. The method according to claim 3, wherein the method comprises transmitting, to a positioning node, the reception timing information.

5. The method according to claim 1, wherein communicating the second reference signal comprises transmitting, to the wireless device, the second reference signal.

6. The method according to claim 1, wherein the second resource configuration comprises information indicative of a processing delay time associated with a delay in processing communication of the second reference signal.

7-8. (canceled)

9. The method according to claim 1, wherein transmitting the first resource configuration and/or the second resource configuration comprises transmitting the first resource configuration and/or the second resource configuration via one or more of: a higher layer signaling and a lower layer signaling.

10. The method according to claim 1, wherein the first reference signal and/or the second reference signal is associated with an identifier.

11. (canceled)

12. The method according to claim 1, wherein the capability signaling is indicative of a processing delay time associated with a delay of the wireless device in processing transmission of the second reference signal.

13. The method according to claim 1, wherein the method comprises performing a round-trip-time (RTT) procedure between the wireless device and the network node.

14. A method, performed by a wireless device, for positioning the wireless device, the method comprising:
receiving, from a network node, a first resource configuration indicative of a first resource to be used for reception of a first reference signal transmitted by a high-altitude node;
receiving, from the network node, a second resource configuration indicative of a second resource to be used for communication of a second reference signal triggered by the reception of the first reference signal;
receiving, from the high-altitude node, the first reference signal in the first resource; and communicating, between the wireless device and the network node, the second reference signal in the second resource.

15. The method according to claim 14, wherein communicating the second reference signal comprises transmitting, to the network node, the second reference signal.

16. The method according to claim 14, wherein communicating the second reference signal comprises receiving, from the network node, the second reference signal.

17. The method according to claim 16, wherein the method comprises determining, based on the first reference signal and the second reference signal, reception timing information indicative of one or more of: a time associated with a reception of the first reference signal, and a time associated with a reception of the second reference signal.

18. The method according to claim 17, wherein the method comprises transmitting, to a positioning node, the reception timing information.

19. The method according to claim 14, wherein the second resource configuration comprises information indicative of a processing delay time associated with a delay in processing communication of the second reference signal.

20. The method according to claim 15 the transmission of the second reference signal is offset to the reception of the first reference signal by the processing delay time.

21-22. (canceled)

23. The method according to claim 14, wherein the first reference signal and/or the second reference signal is associated with an identifier.

24. (canceled)

25. The method according to claim 14, wherein the capability signaling is indicative of a processing delay time associated with a delay of the wireless device in processing transmission of the second reference signal.

26. (canceled)

27. A method, performed by a radio network node, for enabling positioning of a wireless device, the method comprising:
receiving, from a scheduling network node, a first resource configuration indicative of a first resource to be used for reception of a first reference signal transmitted by a high-altitude node;
receiving, from the scheduling network node, a second resource configuration indicative of a second resource to be used for communication of a second reference signal triggered by the reception of the first reference signal;
receiving, from the high-altitude node, the first reference signal in a first resource; and
communicating, between the wireless device and the radio network node, the second reference signal in a second resource.

28-39. (canceled)
